(19) United States
(12) Patent Application Publication
(10) Pub. No.: US 2026/0097359 A1
(43) Pub. Date: Apr. 9, 2026

(54) MULTI-TUBULAR ELECTROCHEMICAL CELL FOR TARGET SPECIES SEPARATIONS

(71) Applicant: Massachusetts Institute of Technology, Cambridge, MA (US)

(72) Inventors: Kyle M. Diederichsen, Cambridge, MA (US); Trevor Alan Hatton, Sudbury, MA (US); Stephen DeWitt, King of Prussia, PA (US); Michael Edward Lev Massen-Hane, Cambridge, MA (US); Younghun Lee, Cambridge, MA (US)

(73) Assignee: Massachusetts Institute of Technology, Cambridge, MA (US)

(21) Appl. No.: 19/113,712

(22) PCT Filed: Sep. 21, 2023
(86) PCT No.: PCT/US2023/033342

§ 371 Date: Mar. 20, 2025

Related U.S. Application Data
(60) Provisional application No. 63/376,447, filed on Sep. 21, 2022.

(51) Int. Cl. B01D 53/32; B01D 53/62

(52) U.S. Cl. CPC B01D 53/326; B01D 53/62; B01D 2257/504

(57) ABSTRACT

Systems and methods for electrochemical target species separation are described herein. In some embodiments, a target species can be transported, in response to an applied voltage, from a fluid in a first electrically conductive tube (e.g., a tubular electrode) that has a low concentration of the target species to a fluid in a second electrically conductive tube (e.g., a tubular electrode) that has a high concentration of the target species. The transport of the target species may involve the diffusion of the target species through porous walls of the first and second tube. In some embodiments, the target species comprises gases such as acid gases (some of which may be commonly exhausted from powerplants and/or industrial processes).

### RELATED APPLICATIONS

This application claims priority under 35 U.S.C. § 119(e) to U.S. Provisional Patent Application No. 63/376,447, filed Sep. 21, 2022, and entitled “MULTI-TUBULAR ELECTROCHEMICAL CELL FOR CARBON DIOXIDE SEPARATIONS,” which is incorporated herein by reference in its entirety for all purposes.

### TECHNICAL FIELD

An apparatus and method regarding electrochemical target species separation is generally described.

### SUMMARY

Systems and methods for electrochemical target species separation are described herein. The subject matter of the present disclosure involves, in some cases, interrelated products, alternative solutions to a particular problem, and/or a plurality of different uses of one or more systems and/or articles.

In one aspect, electrochemical apparatuses for target species separation are provided. In some embodiments, the electrochemical apparatus comprises: a chamber capable of being at least partially filled with an electrolyte solution, the chamber comprising: a first tube, at least a portion of which is surrounded by the electrolyte solution when present, the first tube comprising: a wall comprising a first porous, electrically conductive material; and an inlet configured to receive a first fluid comprising a target species at a first concentration, wherein the first porous, electrically conductive material is configured to allow diffusion of the target species and prevent, when present, electrolyte solution crossover into the first fluid; and a second tube, at least a portion of which is surrounded by the electrolyte solution when present, the second tube being electrically coupled to the first tube, the second tube comprising: a wall comprising a second porous, electrically conductive material; and an outlet configured to output a second fluid comprising the target species at a second concentration, wherein the second porous, electrically conductive material is configured to allow diffusion of the target species and prevent, when present, electrolyte solution crossover into the second fluid.

In another aspect, methods for separating a target species are provided. In some embodiments, the method comprises applying a voltage across a first tube and a second tube such that a target species is transported from a first fluid flowing through at least a portion of the first tube, through an electrolyte solution, into the second tube, thereby forming at least a portion of a second fluid output from an outlet of the second tube; wherein: the first tube comprises: a wall comprising a porous, electrically conductive material; and an inlet configured to receive the first fluid comprising the target species at a first concentration; and the second tube comprises: a wall comprising a porous, electrically conductive material; and the outlet, wherein the outlet is configured to output the second fluid comprising the target species at a second concentration.

One aspect of the disclosure herein is an electrochemical cell comprising a multiplicity of hollow inlet tubes and a multiplicity of hollow outlet tubes, wherein the tubes are configured to transport gases, and wherein the tubes are surrounded by an electrolyte solution, wherein the walls of the tubes comprise a porous, electrically conductive membrane, wherein the membrane is configured to allow diffusion of the gases and prevent liquid crossover into the gases, wherein tubes are electrically connected to a means of applying a voltage between the inlet and outlet tubes, wherein the electrolyte solution upon applying the voltage comprises reactants that react with CO₂ transported into the inlet tubes, and produce CO₂ transported out of the outlet tubes.

In one embodiment of the disclosure herein, the electrolyte solution comprises a glyme-modified naphthoquinone (NQ-G2) derivative dissolved in 1-ethyl-3-methylimidazolium tricyanomethanide ([emim][tcm])

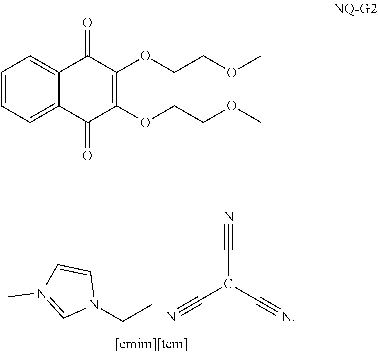

In one embodiment of the disclosure herein, 50% of the NQ-G2 species are reduced to NQ-G2²⁻ before applying a voltage across the walls of the tubes.

In one embodiment of the disclosure herein, the walls of the tubes comprise a hollow fiber membrane coated by multiwalled carbon nanotubes.

In one embodiment of the disclosure herein, the hollow fiber membrane comprises a polypropylene membrane.

One aspect of the disclosure herein is a method of separating CO₂ from a gas stream using the electrochemical cell disclosed herein, comprising pumping the gas comprising CO₂ through the first tube and collecting concentrated CO₂ from the second tube.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic diagram of an electrochemical apparatus for target species separation comprising a chamber and a first tube electrically coupled to a second tube, according to some embodiments.

FIG. 2 is a cross-sectional schematic diagram of an electrochemical apparatus for target species separation comprising a chamber, a first tube comprising a wall comprising a first porous, electrically conductive material, a second tube comprising a wall comprising a second porous, electrically conductive material, an inlet, and an outlet, according to some embodiments.

FIG. 3 is a cross-sectional schematic diagram of an electrochemical apparatus for target species separation comprising a first fluid comprising a target species at a first concentration, a second fluid comprising the target species at a second concentration, a source of the first fluid, and a chamber, according to some embodiments.

FIG. 4 is a cross-sectional schematic diagram of an electrochemical apparatus comprising a chamber comprising an electrolyte solution wherein the electrolyte solution comprises an electroactive species that can reversibly react with the targets species to transport the target species from the first tube to the second tube, through the electrolyte, according to some embodiments.

FIG. 5 is a schematic diagram of an electrochemical apparatus comprising a multiplicity of first tubes, a multiplicity of second tubes, and a chamber capable of being at least partially filled with an electrolyte solution, according to some embodiments.

FIG. 6 is plot of the electrochemistry of NQ-G2 in the presence of CO₂.

FIG. 7 shows cyclic voltammetry (CV) of the NQ-G2 quinone at 20 mM in [emim][tcm] under N₂, CO₂ and 15% CO₂ in N₂, according to some embodiments. Under N₂, two reduction waves are present that merge into a single reduction wave under CO₂. In the mixed gas, the second wave is still present but reduced in size. The oxidation waves under CO₂ also merge and shift positively, consistent with the formation of an adduct between the CO₂ and reduced quinone.

FIG. 8 depicts a plot showing the effect of water on the CV of 20 mM NQ-G2 in [emim][tcm], according to some embodiments.

FIG. 9 depicts a plot showing the bulk capacity of a NQ-G2 solution in [emim][tcm], according to some embodiments.

FIG. 10A is a schematic diagram of the flat cell utilized for the demonstration of an electrochemically pumped liquid membrane, according to some embodiments.

FIG. 10B shows a plot with data during operation of the flat liquid membrane cell depicted. The top panel shows the mass flow of gas leaving the pure CO₂ side of the cell, the second panel shows the composition of the feed gas leaving the cell, reported as a volumetric CO₂ Percentage, and the bottom two panels report the cell current density and potential, respectively.

FIG. 11A is a schematic diagram of a custom box-type bulk reduction cell, according to some embodiments.

FIG. 11B depicts a CV of a reduced quinone solution under CO₂ alongside the original neutral NQ-G2 under N₂ and CO₂, according to some embodiments. to reference the scan.

FIG. 12 shows Electrochemical Impedance Spectroscopy on the flat membrane cell after stabilization, according to some embodiments, with full spectrum on the left and a close-in of the region outlined by a box on the right.

FIG. 13A depicts an overview of the proposed design, according to some embodiments. This figure is a simplified schematic with two conductive, porous tubular electrodes and the electrochemical pumping process between the two tubes.

FIG. 13B depicts a representative diagram of a larger device with multiple tubes, half acting as cathode and half acting as anode, according to some embodiments. Connections are shown to illustrate connections to multiple tubes and gas distribution evenly dispersed over the tubes.

FIG. 14 depicts square packing, hexagonal packing, and A-B packing, which were studied using the outlined unit cells.

FIGS. 15-16 depict a diagram of the four-fiber demonstration cell from the side (FIG. 15) and end (FIG. 16), according to some embodiments. Note that the side view only indicates three of the four tubes, and the second cathode tube is directly behind the one drawn. Gas connections for the tubes are joined in a y-joint prior to the MFM and CO₂ sensor. Wires are connected to the tubular electrodes at both ends of cell, and connected by solder to a single point, shorting all anode connections together and all cathode connections together. Fill ports are included on both sides and are capped during the experiment. FIG. 16 shows the location of the fill ports utilized to fill the chamber with the reduced NQ-G2 in [emim][tcm] solution, according to some embodiments.

FIG. 17A depicts an optical image of a coated fiber, with the wire apparent as a slight ridge beneath the CNT coating, according to some embodiments.

FIG. 17B depicts the coating of hollow fiber membranes. FIG. 17B includes a schematic of the trough coating setup with a trough filled with the CNT solution and a fiber epoxied at the bottom of the trough attached to a vacuum connection, according to some embodiments. A thin wire is wrapped around the fiber prior to coating.

FIG. 18 depicts the operation of a four-tube cell, according to some embodiments. The top panel shows the mass flow of gas leaving the pure CO₂ side of the cell, the second panel shows the composition of the feed gas leaving the cell, reported as a volumetric CO₂ Percentage, and the bottom two panels report the cell current density and potential, respectively.

FIG. 19 shows an experimental demonstration of the multi-tubular cell, showing the total pure CO₂ flow rate leaving the cell (combined exit from the two anodic/desorption tubes), the composition of the exiting feed gas stream (mixed from the two cathodic/absorption tubes), the total current density applied to the cell, and the cell potential as a function of the elapsed experiment time. Initially, and after the experiment, (shaded regions) the cell is bypassed so the entering gas directly enters the sensors, according to some embodiments. This shows the baseline readings. When the flow is through the cell, there is crossover from the pure CO₂ to the lower concentration feed stream. The dashed line shows the entering flow and feed composition. When the cell is turned on, CO₂ is captured from the lower concentration side and released at the pure CO₂ side, causing a decrease in the exit gas composition and an increase in the flow of CO₂ from the cell.

FIG. 20A depicts a representative three-dimensional hollow fiber architecture with absorption tubes arranged vertically and desorption tubes arranged horizontally, according to some embodiments.

FIG. 20B depicts headers on the closed unit can allow for distribution and collection of the gas feed and sweep streams over their respective tube bundles, according to some embodiments.

FIG. 21A depicts representative chemistries for the electrochemically pumped liquid membrane, according to some embodiments, in the form of a pH swing cycle (left) and an example of a quinone derivative that can cause a pH change under applied potentials in water.

FIG. 21B depicts representative molecules that can undergo redox events that bind reversibly to CO₂, according to some embodiments.

FIG. 22 depicts the structure of the NQ-G2 naphthoquinone derivative and the ionic liquid 1-ethyl-3-methylimidazolium tricyanomethanide ([emim][tcm]) used in a demonstration experiment, according to some embodiments.

FIGS. 23A-23D show annotated photographs of one example of an embodiment of an electrochemical apparatus for target species separation using a cell employing tubes comprising silver nanoparticle-coated hollow fibers, according to some embodiments.

### DETAILED DESCRIPTION

Systems and methods for electrochemical target species separation are described herein. In some embodiments, a target species can be transported, in response to an applied voltage, from a fluid in a first electrically conductive tube (e.g., a tubular electrode) that has a low concentration of the target species to a fluid in a second electrically conductive tube (e.g., a tubular electrode) that has a high concentration of the target species. The transport of the target species may involve the diffusion of the target species through porous walls of the first and second tube. In some embodiments, the target species comprises gases such as acid gases (e.g., some of which may be commonly exhausted from powerplants and/or industrial processes).

The capture of target species (e.g., from fluid streams) is an industrially, environmentally, and commercially important process. For example, processes to capture CO₂ from large point sources, from the atmosphere, and more recently from the ocean are now seen as important components to achieve net-zero or net-negative emissions. Such processes have been studied for over 100 years, focused primarily on adsorption and absorption materials which reversibly capture and release CO₂ under applied pressure and temperature swings. While recent advances have improved the cost and energetic penalty of these pressure- and temperature-based processes, still further improvements are necessary.

Electrochemically mediated carbon capture has drawn attention in the last several years as a means of potentially improving the energetics, stability, and versatility of carbon capture. Such processes modulate sorbent affinity for CO₂ through the application of electric potentials within electrochemical cells, enabling isothermal and isobaric operation in flexible formats that can be tied directly to renewable electricity.

Processes to separate carbon dioxide from gas streams including air and flue gases from power plants and other point sources generally require efficient gas contacting methods to enable rapid uptake of CO₂ into the sorbent media. This gas contacting operation is dependent on the method of capture, where typical reactive liquid amine-based processes would use large absorption columns, adsorption-based processes would typically utilize porous, packed-bed configurations, while membranes would be fabricated in layered structures or as hollow fibers. The use of electrochemistry to drive the CO₂ separation offers the opportunity for low energy requirements and new flexible formats driven entirely by renewable electricity. Many different formats of electrochemically mediated carbon capture have been proposed, including liquid flow and static, solid-supported capture agents. Embodiments of this invention, in some aspects, concern electrochemical devices that make use of a liquid membrane between porous electrodes.

Liquid membranes that pump CO₂ or other gases up a concentration gradient through the application of an electrochemical potential were first proposed in the 1960s as life support systems in spacecraft. These early devices operated as a carbonate fuel cell where oxygen is reduced at a cathode, generating hydroxide ions in water that react with CO₂. At the anode, the pH is lowered by water splitting, releasing a stream of CO₂ and oxygen. Since then, similar processes based on pH gradients have been proposed, cither employing different water splitting arrangements with hydrogen feed gas or with a proton-coupled electron transfer employing redox-active quinones. Given the need for feed water in these systems to prevent drying, nonvolatile ionic liquids have also been proposed in combination with organic redox molecules that selectively bind to CO₂ in their reduced state, such as quinones. It is believed that all present examples of devices that utilize these types of chemistries are planar cells with flat membranes and porous gas diffusion electrodes.

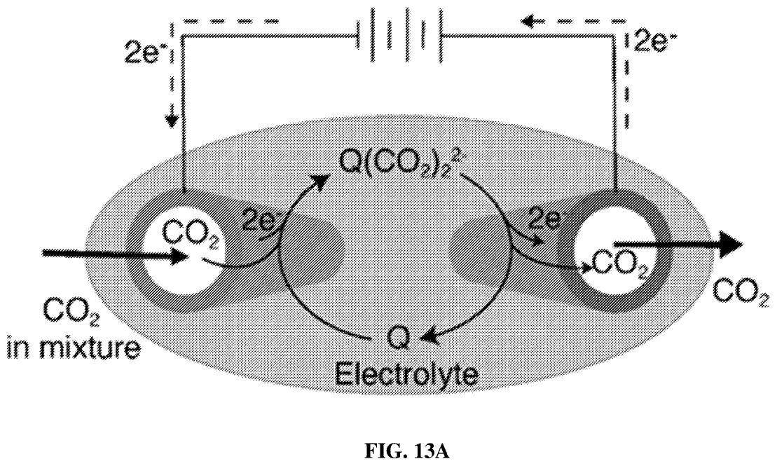

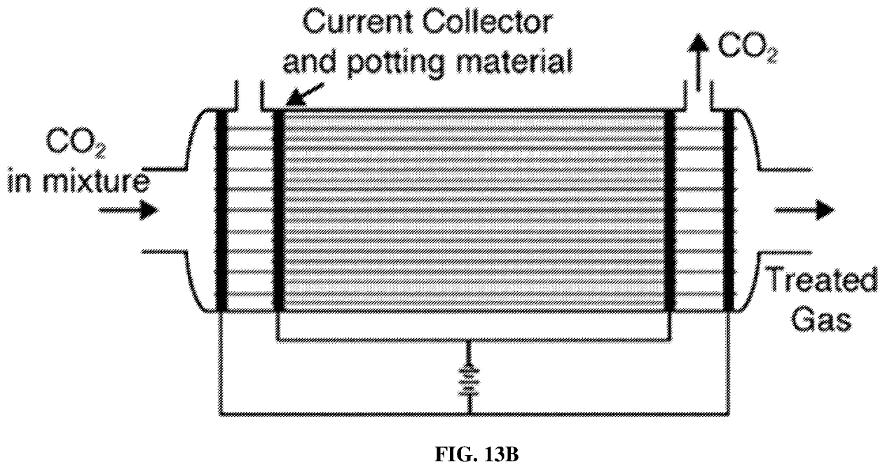

Aspects of this disclosure are directed to a new electrochemical cell design that facilitates highly efficient gas contacting in a compact, versatile format. The concept, using CO₂ as a target species purely for illustrative purposes in accordance with some embodiments, is illustrated generally in FIG. 13A and FIG. 13B. In the simplest case illustrated in FIG. 13A, the cell is composed of two hollow tubes surrounded by an electrolyte. Through one tube, a flow of gas with CO₂ at low concentration is fed. The tube is composed of a porous, electrically conductive membrane that allows gas transport but prevents liquid crossover into the gas stream. A voltage or current is applied to a circuit between the two electrically conductive membranes to drive an electrochemical process within the liquid that selectively uptakes CO₂ from the gas stream and drives it up a concentration gradient towards the second conductive, porous hollow tube. At the second tube, the CO₂ is released from the solution by the electrochemical process and flows out of the cell in a concentrated stream inside of the hollow tube. This second tube may be fed by a sweep stream to facilitate efficient gas release from the cell. In this way, one tube acts as the cathode capturing CO₂ while the other acts as the anode, releasing CO₂. The advantage of the symmetric tubular electrode concept proposed here is illustrated in FIG. 13B, where instead of two individual electrodes, many tubes are employed as banks of electrodes arranged within a larger volume of electrolyte. In this novel geometry, the area for mass transfer and electrochemical reaction within the volume of the cell is substantially increased while maintaining the liquid membrane between all the anode and cathode tubes. This geometry also facilitates several possible extensions such as the addition of convection and mixing throughout the cell volume, and a wide variety of potential tube layouts to optimize cell efficiency.

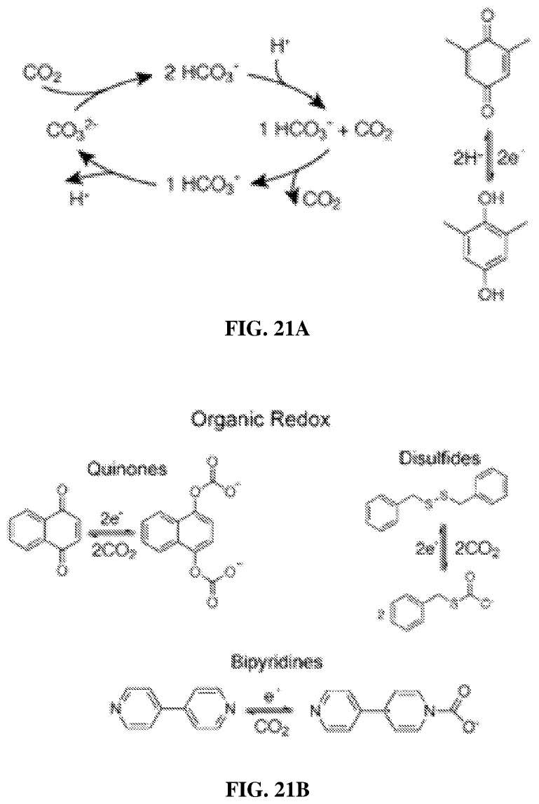

This conceptual cell design can be employed with any of a myriad of electrochemical processes that operate within a static liquid membrane, as illustrated in FIG. 21. These include but are not limited to those that create a pH gradient (FIG. 21A) and those that utilize organic redox processes (FIG. 21B). In some cases the CO₂ is desorbed at the anode of the electrochemical cell, effectively pumping CO₂ from a low concentration to a high concentration and overcoming the natural diffusion of CO₂ down this concentration gradient. An alternative configuration includes the use of a sweep stream at the desorption side to readily remove the captured CO₂.

Certain embodiments disclosed herein include an electrochemical cell comprising a multiplicity of hollow inlet tubes and a multiplicity of hollow outlet tubes, wherein the tubes are configured to transport gases, and wherein the tubes are surrounded by an electrolyte solution, wherein the walls of the tubes comprise a porous, electrically conductive membrane, wherein the membrane is configured to allow diffusion of the gases and prevent liquid crossover into the gases, wherein tubes are electrically connected to a means of applying a voltage between the inlet and outlet tubes, wherein the electrolyte solution upon applying the voltage comprises reactants that react with CO₂ transported into the inlet tubes, and produce CO₂ transported out of the outlet tubes. Any of a variety of equipment may be used to apply a voltage across tubes (e.g., between the inlet and outlet tubes). For example, an external voltage source such as a potentiostat and/or an external battery may be used.

In one aspect, systems for target species separation are described (e.g. gaseous separation, liquid separation). The system may include an electrochemical apparatus. The electrochemical apparatus may comprise, for example, an electrochemical cell (e.g., an electrolytic cell). The apparatus may comprise a chamber capable of being at least partially filled with an electrolyte solution, a first tube, and a second tube. In some embodiments, the electrochemical apparatus is configured such that there is a relatively small distance between any portion of the first tube and the second tube (e.g., to promote efficient mass transport of target species from the first tube to the second tube). The second tube may be electrically coupled to the first tube (e.g., as electrodes in an electrochemical cell). The first tube may comprise a first fluid comprising a target species at a first concentration. In some embodiments, the second tube comprises a second fluid comprising the target species at a second, different concentration. In some embodiments, the first tube comprises a wall comprising a first porous, electrically conductive material. In some embodiments, the second tube comprises a wall comprising a second porous, electrically conductive material. The apparatus may be configured such that when a voltage and/or electrical current is applied across the first tube and the second tube, the target species can be transported from the first fluid, through the electrolyte solution, into the second tube, thereby forming at least a portion of the second fluid.

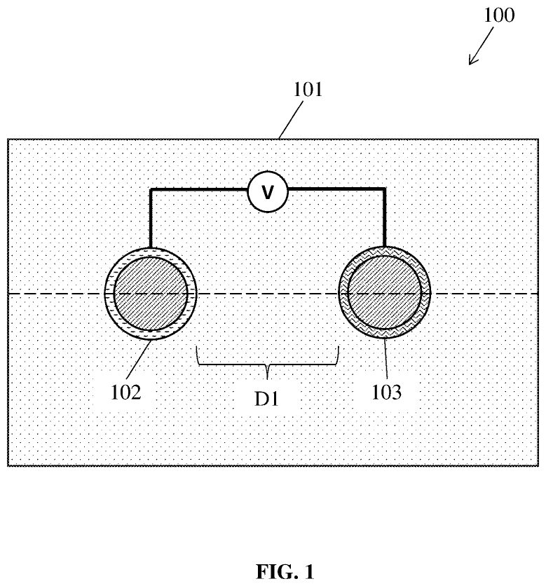

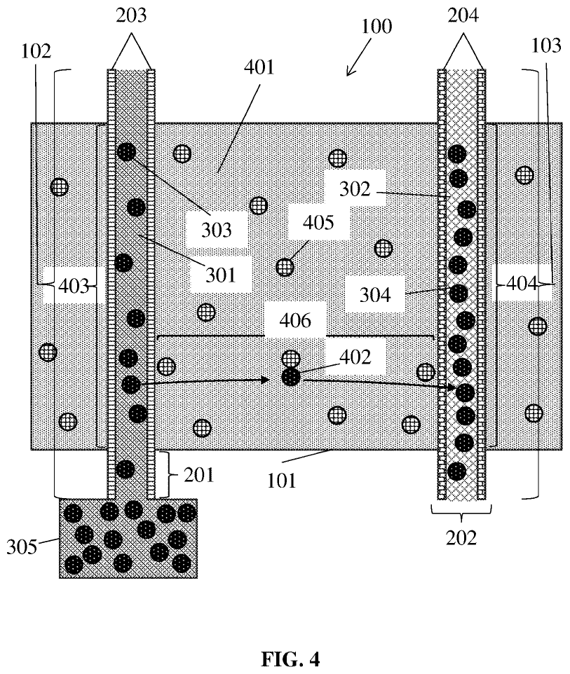

In some embodiments, the electrochemical apparatus comprises a chamber. The chamber may be capable of being at least partially filled with an electrolyte solution (e.g., a liquid electrolyte solution). For example, in the embodiment shown in FIG. 1, chamber 101 of electrochemical apparatus 100 may be capable of being at least partially filled with an electrolyte solution such shown in FIG. 4 with electrolyte solution 401. The chamber may include at least one or more openings to introduce, remove, and/or replace electrolyte solution. The chamber may be capable of containing a sufficient quantity of the electrolyte solution to surround at least a portion of the first tube and/or at least a portion of the second tube. In some cases, the chamber comprises a mechanism configured to convect and/or mix the electrolyte solution and/or components therein (e.g., via agitation). For example, the mechanism may include one or more of a stirrer, an impeller, and/or a propeller. Convection of the electrolyte solution during operation of the electrochemical apparatus may improve the rate and/or yield of target species transport (e.g., from the first tube to the second tube).

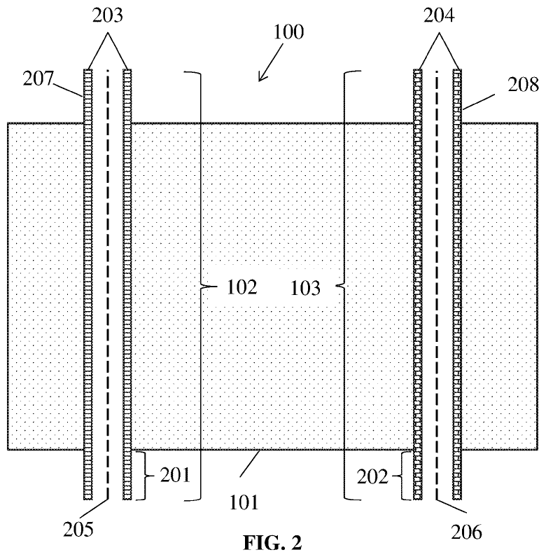

The first tube and/or second tube may each independently have any of a myriad of cross-sectional geometries and/or form factors. In some embodiments, at least a portion of the first tube and/or at least a portion of the second tube has a cross-section in a geometric plane perpendicular to the long axis of the tube that has an elliptical shape. For example, in FIG. 1, first tube 102 and second tube 103 have circular cross-sections. Of course, the description of cross-sectional shapes in terms of geometrical shapes should be understood to encompass shapes with minor deviations from the exact shapes. In some embodiments, the geometric plane of the circular cross-section is perpendicular to the long-axis of the first tube and/or the second tube. For example, in FIG. 2, first tube 102 has long axis 205 and second tube 103 has long axis 206. However, the first tube and/or second tube need not have a an elliptical (e.g., circular) cross-section. In some embodiments, the first tube and/or the second tube has any of a variety other cross-sectional shapes (e.g. rectangular (e.g., square), rhomboid, triangular, polygons with greater numbers of side, star-shaped). In some cases, the first tube and/or the second tube comprises at least two or more different cross-sectional shapes and/or sizes at different locations along the long axis (e.g., hour-glass shape, square-to-round). At least a portion of the first tube may have a cross-sectional shape in a geometric plane perpendicular to the long axis of the tube that is the same as that of at least a portion of the second tube. However, in some embodiments, at least a portion of the first tube has a cross-sectional shape in a geometric plane perpendicular to the long axis of the tube that is the different than that of at least a portion of the second tube.

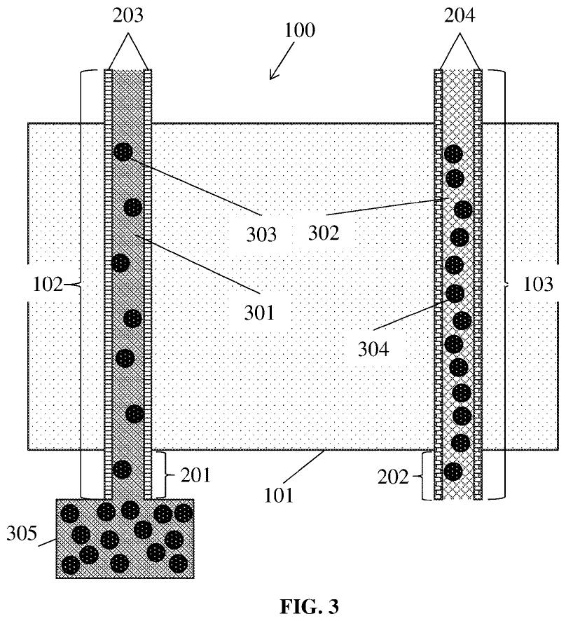

In some embodiments, the first tube and/or the second tube comprises a hollow member. A hollow member may comprise an interior volume surrounded by solid material, with the interior volume capable of being filled with a fluid (e.g., a gas and/or liquid). In some instances, at least 10 volume percent (vol %), at least 25 vol %, at least 50 vol %, at least 75 vol %, at least 90 vol %, and/or up to 95 vol % or more of the total volume of the hollow member is in the form of an interior volume capable of being filled with a fluid. For example, in the embodiment shown in FIG. 3, first tube 102 and second tube 103 may be considered hollow, as first tube 102 and second tube 103 are capable of being filled with a fluid, in this embodiment first fluid 301 in first tube 102 and second fluid 302 in second tube 103. In other words, hollow members may comprise at least one or more voids in at least a portion of the hollow member that make up an interior volume of the first tube and/or second tube.

In some instances, the first tube and/or the second tube comprises an elongated member. In some embodiments, the elongated member has an aspect ratio that is relatively high. For example, the elongated member (e.g., of the first tube) has an aspect ratio of greater than or equal to 1.5, greater than or equal to 2, greater than or equal to 5, greater than or equal to 10, greater than or equal to 20, greater than or equal to 50, and/or up to 100, up to 500, or greater. The aspect ratio, in this context, is defined as follows:

$$A R = \frac{L}{W} \qquad Equation 1$$

where AR represents the aspect ratio, L represents the length of the longest axis of the elongated member, and W represents the largest cross-sectional dimension in a geometric plane perpendicular to the long axis of the tube. In some instances, the first and/or second tube comprises a hollow, elongated member.

In some embodiments, the first tube and/or the second tube has a relatively small outer diameter (e.g., an outer diameter of less than or equal to 5 mm, less than or equal to 2 mm, less than or equal to 1 mm, less than or equal to 0.8 mm, less than or equal to 0.5 mm, less than or equal to 0.2 mm, and/or as low as 0.1 mm, or less). Combinations of these ranges are possible.

In some embodiments, the first tube and/or the second tube has a relatively small inner diameter (e.g., an outer diameter of less than or equal to 4 mm, less than or equal to 2 mm, less than or equal to 1 mm, less than or equal to 0.8 mm, less than or equal to 0.5 mm, less than or equal to 0.2 mm, and/or as low as 0.1 mm, or less). Combinations of these ranges are possible.

In some embodiments, the first tube and/or the second tube is or is part of an electrode of the electrochemical apparatus. In some cases, the first tube comprises an anode of the electrochemical apparatus. In some embodiments, the second tube comprises the cathode of the electrochemical apparatus. In this context, the anode of an electrochemical apparatus is the electrode in an electrochemical apparatus where oxidation (e.g., loss of electrons, remove electrons from) occurs. In this context, the cathode of an electrochemical apparatus is the electrode in an electrochemical apparatus where reduction (e.g., gain of electrons, add electrons to) occurs. In some embodiments, the first tube is or is part of a first electrode of an electrochemical cell of the electrochemical apparatus, and the second tube is or is part of a second electrode of the electrochemical cell having an opposite polarity as the first electrode (e.g., such that one of the first tube and/or second tube serves as an anode and the other of the first tube and/or second tube serves as a cathode when the electrochemical cell operates). One non-limiting way in which a tube can be part of an electrode is where an electrically conductive wire contacts at least a portion of an electrically conductive portion of the tube (e.g., an electrically conductive, porous material of a wall of the tube). The wire may serve as a current collector for the electrode. For example, the wire may be wrapped around at least a portion of the tube.

In some embodiments, at least a portion of the first tube and/or at least a portion the second tube is surrounded by the electrolyte solution when present. When present, the electrolyte solution can at least partially (e.g., partially or completely) surround at least a portion of the first tube and/or second tube. In some embodiments, at least 1%, at least 5%, at least 10%, at least 15%, at least 20%, at least 25%, at least 50%, at least 75%, at least 80%, at least 85%, at least 90%, at least 95%, or at least 99% of the external surface area of the first tube and/or the second is surrounded by the electrolyte when present. In some embodiments, the electrolyte solution is in direct contact with at least a portion of the first tube and/or at least a portion of the second tube. For example, electrolyte solution 401 is in direct contact with portion 403 of first tube 102 and/or portion 404 of second tube 103.

In some embodiments, the first tube comprises a wall. For example, in FIG. 2, first tube 102 comprises wall 203. The wall may comprise any of a variety of solid materials. The wall of the tube may comprise first porous, electrically conductive material 207. In some such instances, an entirety of the wall is the first porous, electrically conductive material. However, in other embodiments, only a portion of the wall is the first porous, electrically conductive material. For example, the first porous, electrically conductive material may be an electrically conductive coating on a separate portion of the wall of a different material, such as a polymeric material. For example, the tube may comprise a hollow fiber membrane. The hollow fiber membrane (e.g., of a polymeric material such as polypropylene and/or polyetherimide) may be coated (e.g., via dip-coating) with an electrically conductive material. The wall may separate the electrolyte solution when present and the external environment from the interior of the first tube. The first porous, electrically conductive material may prevent the electrolyte from entering the interior of the first tube while allowing the target species at the first concentration to be transported from the first tube into the electrolyte solution (e.g., as part of a process of the target species being transported to the second tube). In some embodiments, the first porous, electrically conductive material is configured to allow diffusion of the target species and prevent, when present, electrolyte solution crossover into the first fluid.

In some embodiments, the wall of the first tube and/or the wall of the second tube (described below) has a relatively small average thickness. For example, the wall of the first tube and/or the wall of the second tube may have an average thickness of less than or equal to 0.5 mm, less than or equal to 0.2 mm, less than or equal to 0.1 mm, less than or equal to 0.05 mm, and/or as low as 0.01 mm or lower. Combinations of these ranges are possible.

In some embodiments, the first porous electrically conductive material and/or the second porous, electrically conductive material (described below) is present as a layer of the wall, the layer having a relatively small average thickness (e.g., of less than or equal to 100 microns, less than or equal to 50 microns, less than or equal to 20 microns, less than or equal to 10 microns, and/or as low as 5 microns, as low as 2 microns, as low as 1 micron, as low as 50 nm, or lower. Combinations of these ranges are possible.

The first porous, electrically conductive material may have a porosity that is sufficient for target species to be transported through the wall of the first tube but insufficient for the electrolyte solution to permeate. In some embodiments, the first porous electrically conductive material has a porosity greater than or equal to 1%, greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, or greater. The porosity refers to the volume of voids within the porous, electrically conductive material relative to the volume of the overall porous, electrically conductive material. In some embodiments, the first porous electrically conductive material has a porosity less than or equal to 90%, less than or equal to 80%, less than or equal to 70%, less than or equal to 60%, less than or equal to 50%, less than or equal to 40%, less than or equal to 30%, less than or equal to 20%, less than or equal to 10%, less than or equal to 5%, or less. Combinations of ranges are also possible (e.g, greater than 10% and less than or equal to 90%, greater than 10% and less than 50%). Other properties of the electrochemical apparatus can be modified to control the prevention of electrolyte solution infiltration into the first fluid in the first tube (e.g., first fluid pressure, liquid/gaseous phases, polar/nonpolar compounds, electrode surface morphology, use of differences in hydrophobicity and/or hydrophilicity of the wall of the first tube and the electrolyte solution, and/or viscosity (e.g., dynamic and/or kinematic viscosity) of the electrolyte solution (where the higher the viscosity, the more difficult it is for the electrolyte solution to pass through the wall of the tube)).

In some embodiments, the first porous, electrically conductive material has an average pore size. In some embodiments, the first porous, electrically conductive material has an average pore size of less than or equal to 500 μm, less than or equal to 300 μm, less than or equal to 200 μm, less than or equal to 100 μm, less than or equal to 50 μm, less than or equal to 25 μm, less than or equal to 20 μm, less than or equal to 15 μm, less than or equal to 10 μm, less than or equal to 5 μm, less than or equal to 4 μm, less than or equal to 3 μm, less than or equal to 2 μm, less than or equal to 1 μm, less than or equal to 0.9 μm, less than or equal to 0.8 μm, less than or equal to 0.7 μm, less than or equal to 0.6 μm, less than or equal to 0.5 μm, less than or equal to 0.4 μm, less than or equal to 0.3 μm, less than or equal to 0.2 μm, less than or equal to 0.1 μm, less than or equal to 90 nm, less than or equal to 80 nm, less than or equal to 70 nm, less than or equal to 60 nm, less than or equal to 50 nm, or less. In some embodiments, the first porous, electrically conductive material has an average pore size of greater than or equal to 2 nm, greater than or equal to 5 nm, greater than or equal to 10 nm, greater than or equal to 20 nm, greater than or equal to 50 nm, greater than or equal to 60 nm, greater than or equal to 70 nm, greater than or equal to 80 nm, greater than or equal to 90 nm, greater than or equal to 0.1 μm, greater than or equal to 0.2 μm, greater than or equal to 0.3 μm, greater than or equal to 0.4 μm, greater than or equal to 0.5 μm, greater than or equal to 0.6 μm, greater than or equal to 0.7 μm, greater than or equal to 0.8 μm, greater than or equal to 0.9 μm, greater than or equal to 1 μm, greater than or equal to 2 μm, greater than or equal to 3 μm, greater than or equal to 4 μm, greater than or equal to 5 μm, greater than or equal to 10 μm, greater than or equal to 15 μm, greater than or equal to 20 μm, greater than or equal to 25 μm, greater than or equal to 50 μm, greater than or equal to 100 μm, or greater. Combinations of these ranges are possible (e.g., greater than or equal to 50 nm and less than or equal to 20 μm). Average pore size can be determined using porosimetry techniques.

In some embodiments, the porous, electrically conductive material has a low electrical resistance. In some embodiments, the porous, electrically conductive material is or comprises a metallic material and/or metallic alloy (e.g., copper and/or copper alloys, silver and/or silver alloys, gold and/or gold alloys, aluminum and/or aluminum alloys, zinc and/or zinc alloys, nickel and/or nickel alloys, brass, bronze, iron and/or iron alloys, and/or platinum and/or platinum alloys). The porous, electrically conductive material, in some embodiments, comprises conductive nanomaterials including but not limited to single-walled carbon nanotubes, multi-wall carbon nanotubes, silver nanoparticles, silver nanowires, and/or gold nanoparticles. In some embodiments, the porous, electrically conductive material has a sheet resistance of less than or equal to 100 Ω/cm², less than or equal to 50 Ω/cm², less than or equal to 20 Ω/cm², less than or equal to 10 Ω/cm², less than or equal to 5 Ω/cm², less than or equal to 4 Ω/cm², less than or equal to 3 Ω/cm², less than or equal to 2 Ω/cm², less than or equal to 1 Ω/cm², less than or equal to 0.5 Ω/cm² and/or less than or equal to 0.1 Ω/cm². In some embodiments, the porous, electrically conductive material has a sheet resistance or greater than or equal to 0.1 Ω/cm², greater than or equal to 0.5 Ω/cm², greater than or equal to 1 Ω/cm², greater than or equal to 2 Ω/cm², greater than or equal to 3 Ω/cm², greater than or equal to 4 Ω/cm², greater than or equal to 5 Ω/cm², greater than or equal to 10 Ω/cm², greater than or equal to 20 Ω/cm², greater than or equal to 50 Ω/cm², and/or greater than or equal to 50 Ω/cm². Combinations of these ranges are possible (e.g., greater than or equal to 0.1 Ω/cm² and less than or equal to 50 Ω/cm²).

In some embodiments, the first tube comprises an inlet configured to receive the first fluid. The inlet can, in some cases, be fluidically connected to a source of the first fluid. For example, in FIG. 3, first tube 102 comprises inlet 201 configured to receive first fluid 301 from source 305 of first fluid 301. While the location of the inlet relative to the first tube can vary, in some embodiments, the inlet is be located at an end of the first tube. The inlet may be configured to introduce the first fluid into the first tube such that the target species can be introduced into the electrochemical apparatus. In some cases, the first tube comprises multiple inlets configured to receive fluids. In some embodiments, the first fluid is present in at least a portion of the first tube. The first fluid may be introduced into the first tube via the inlet along with other fluids introduced into the first tube.

In some embodiments, the first tube comprises an outlet configured to output the first fluid. In some embodiments, the outlet is located at an end of the first tube. In some embodiments, the first tube comprises a multiplicity of outlets configured to output the first fluid from the first tube.

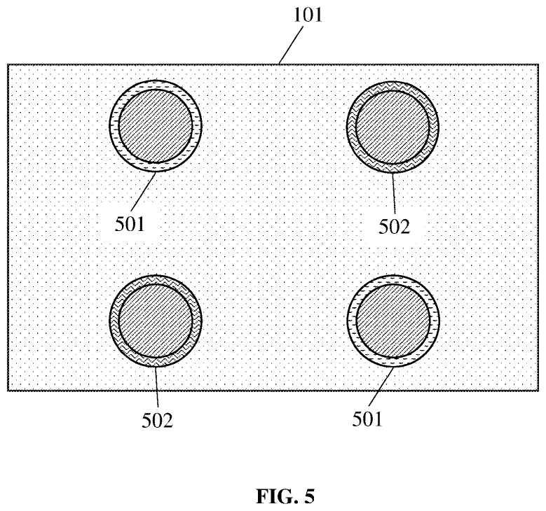

In some embodiments, the first tube is one of a multiplicity of first tubes. In the electrochemical apparatus, it may be beneficial to large-scale target species separation methods to have multiple first tubes in the electrochemical apparatus to improve throughput. For example, in FIG. 5, electrochemical apparatus 100 comprises a multiplicity of first tubes 501. In some embodiments, the multiplicity of first tubes comprises tubes of various geometries, lengths, materials, and/or properties. However, in some embodiments, some or all first tubes of the multiplicity of first tubes have the same geometry, materials, and/or properties. In some embodiments, the multiplicity of first tubes are parallel to each other. In some embodiments, the multiplicity of tubes are perpendicular and/or parallel to each other. In some embodiments, each of the first tubes of the multiplicity of first tubes comprises an inlet configured to receive the first fluid. In some such embodiments, each of the first tubes of the multiplicity of first tubes is fluidically connected to one or more sources of the first fluid (e.g., a common source of the first fluid or different sources of the first fluid).

In some embodiments, the first fluid comprises a target species at a first concentration. For example, in FIG. 3, first fluid 301 comprises the target species at first concentration 303. The first fluid may be a liquid, a gas, and/or both (e.g. fluid stream of gaseous and liquid particles, aerosolized liquids). In some embodiments, the first fluid comprises fluidic waste (e.g., flue gases, exhaust gases) from commercial and/or industrial processes. In some embodiments, the first fluid comprises the target species at a concentration of less than or equal to 99%, less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, less than or equal to 1%, less than or equal to 0.5%, less than or equal to 0.1%, less than or equal to 0.05%, or less, wherein the percentage is the volumetric percentage of the target species relative to the first fluid. In some embodiments, the first fluid comprises the target species at a concentration of greater than or equal to 0.04%, greater than or equal to 0.05%, greater than or equal to 0.1%, greater than or equal to 0.5%, greater than or equal to 1%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, greater than or equal to 95%, greater than or equal to 99%, or greater, wherein the percentage is the volumetric percentage of the target species relative to the first fluid. Combinations of these ranges are possible (e.g., greater than or equal to 10% and less than and equal to 50%).

In some embodiments, the first fluid comprises the target species at a concentration of less than or equal to 99%, less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, less than or equal to 1%, less than or equal to 0.5%, less than or equal to 0.1%, less than or equal to 0.05%, or less, wherein the percentage is the weight percentage of the target species relative to the first fluid. In some embodiments, the first fluid comprises the target species at a concentration of greater than or equal to 0.04%, greater than or equal to 0.05%, greater than or equal to 0.1%, greater than or equal to 0.5%, greater than or equal to 1%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, greater than or equal to 95%, greater than or equal to 99%, or greater, wherein the percentage is the weight percentage of the target species relative to the first fluid. Combinations of these ranges are possible (e.g., greater than or equal to 10% and less than and equal to 50%).

In some embodiments, the first fluid is in a first phase (e.g., a liquid, a gas, a polar fluid, a nonpolar fluid). In some embodiments, the first phase is different than the phase of the electrolyte solution. For example, the first phase may be a gaseous phase and the electrolyte solution may be in a liquid phase. In some cases, the first fluid is in a first phase (e.g., a first liquid phase) that is immiscible with at least one phase of the electrolyte solution (e.g., a liquid phase of the electrolyte solution). The use of immiscible phases between the first fluid and the electrolyte solution may limit the amount or quantity of electrolyte solution crossover into the first fluid. In some embodiments, the first tube can receive the first fluid at a first pressure. The first fluid may be pressurized to improve throughput, ensure adequate diffusion of the target species out of the first tube, and/or limit the quantity of electrolyte solution crossover into the first tube.

In some embodiments, the electrochemical apparatus is configured to release the first fluid from the first tube via an outlet on the first tube. In some embodiments, the first fluid that is released from the first tube comprises the target species at a lower concentration than that of the first fluid introduced into the first tube (e.g., by a factor of at least 1.05, at least 1.1, at least 1.2, at least 1.5, at least 2, at least 5, at least 10, at least 50, at least 100, and/or up to 1000 or more). The target species, after being introduced into the first tube at the inlet, may be transported from the first tube into the second tube, through the electrolyte. Accordingly, the concentration of the target species at the outlet of the first tube can be lower than the concentration of the target species at the inlet of the first tube.

In some embodiments, the first fluid comprises a target species. In some embodiments, the first fluid comprises a target species at a first concentration. In FIG. 4, target species at first concentration 303 is depicted within first tube 102. In some embodiments, the target species forms at least a portion of the first fluid (e.g., the target species is at least one of numerous components in the first fluid). In some embodiments, the target species can reversibly react with the electrolyte and/or a component in the electrolyte (e.g., an electroactive species). When the target species reversibly reacts with the electrolyte, the target species may exhibit characteristics (e.g., changes in chemical compositions and/or structure) of a first chemical transformation after the reaction. However, the aforementioned characteristics can be reversed via a second chemical reaction to yield the target species again. Additional details regarding the reversible reacting of the target species with the electrolyte are described elsewhere in this disclosure.

In some embodiments, the target species comprises a gaseous species (e.g., at 298 K and 1 atm). In some embodiments, the target species is or comprises an acid gas. It should be understood that while acid gas is described as being a gas, the acid gas may be dissolved in a liquid during at least a portion of the separation process (e.g., when in the first fluid, the electrolyte solution, and/or the second fluid). For example, in some embodiments in which the acid gas is carbon dioxide, a gaseous stream of carbon dioxide may be bubbled into a liquid solution (e.g., an aqueous liquid solution) comprising dissolved electroactive species (e.g., in its activated state), and a portion of the bubbled carbon dioxide may dissolve in the liquid solution and encounter the sorbent (e.g., for capture).

In some embodiments, the acid gas comprises a Lewis acid. In some embodiments, the acid gas is an aprotic acid gas. In some embodiments, the acid gas comprises carbon dioxide. In some embodiments, the acid gas comprises a Brønsted-Lowry acid or an anhydride of a Brønsted-Lowry acid. A Brønsted-Lowry acid refers to any species that can donate a proton (H⁺) to another species. Examples of anhydrides of Brønsted-Lowry acids include, but are not limited to carbon dioxide (which can form the Brønsted-Lowry acid carbonic acid upon addition of water), sulfur dioxide (which can form the Brønsted-Lowry acid sulfurous acid upon addition of water), sulfur trioxide (which can form the Brønsted-Lowry acid sulfuric acid upon addition of water), and N₂O₅ (which can form the Brønsted-Lowry acid nitric acid upon addition of water). In some embodiments, acid gas is a sulfur-containing species (e.g., a gaseous sulfur oxide species). In some embodiments, the acid gas comprises a nitrogen-containing species (e.g., a gaseous nitrogen oxide species). In some embodiments, the acid gas comprises one or more boranes (e.g., BH₃). In some embodiments, the acid gas comprises a hydride of a halogen (e.g., HF, HCl, HBr, HI). In some embodiments, the acid gas comprises CO₂, SOₓ, NOₓ, H₂S, HF, HCl, HBr, HI, a borane, and/or Cl₂O. In some embodiments, the target species comprises CO₂.

The target species may be a molecular species. In some embodiments, the target species comprises an organic species. In some embodiments, the target species comprises an alkane, an alkene, and/or an alkyne. Target species comprising alkanes, alkenes, and/or alkynes may derive from hydrocarbon feedstocks and be used in the production of any of a myriad of commercial and/or industrial products (e.g. gasolines, diesel, lubricants, plastics). Some examples of alkanes include but are not limited to methane, ethane, propane, butane, pentane, hexane, heptane, octane, nonane, decane, and/or other compounds with a general chemical formula of CₙH₂ₙ₊₂. Some examples of alkenes include but are not limited to ethene, propene, 1-butene, isobutylene, 1-pentene, 1-hexene, and/or other compounds with a general chemical formula of CₙH₂ₙ. Some examples of alkynes include but are not limited to acetylene, propyne, 1-butyne, 1-pentyne, 1-hexyne, and/or other compounds with a general chemical formula of CₙH₂ₙ₋₂.

In some embodiments, the target species comprises an ionic species. For example, the target species may comprise a metal cation (e.g., lithium cation, sodium cation, potassium cation, magnesium cation, calcium cation, heavy metal cations). As another example, the target species may comprise an anion (e.g., a halide, sulfate, sulfite, nitrate, nitrite, borate, phosphate, carbonate, bicarbonate).

In some embodiments, the target species may enter the electrochemical apparatus at any of a range of temperatures. In some embodiments, the target species enter the electrochemical apparatus at a temperature of greater than or equal to −50° C., greater than or equal to −40° C., greater than or equal to −30° C., greater than or equal to −20° C., greater than or equal to −10° C., greater than or equal to −0° C., greater than or equal to 10° C., greater than or equal to 20° C., greater than or equal to 30° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C. greater than or equal to 160° C., greater than or equal to 170° C., greater than or equal to 180° C., greater than or equal to 190° C., greater than or equal to 190° C., greater than or equal to 200° C., or greater. In some embodiments, the liquid species and/or the gaseous species can have a temperature of less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., less than or equal to 90° C., less than or equal to 80° C., less than or equal to 70° C., less than or equal to 60° C., less than or equal to 50° C., less than or equal to 40° C., less than or equal to 30° C., less than or equal to 20° C., less than or equal to 10° C., less than or equal to 0° C., less than or equal to −10° C., less than or equal to −20° C., less than or equal to −30° C., less than or equal to −40° C., less than or equal to −50° C., or less Combinations of these ranges are possible (e.g, greater than or equal to −50° C. and less than or equal to 200° C., greater than or equal to −30° C. and less than or equal to 100° C.). In this context, the temperature at which the target species enters the electrochemical apparatus refers to the spatially averaged temperature across the cross-section perpendicular to the pathway along which the target species are transported as they enter the electrochemical apparatus.

In some embodiments, the target species is present in the first fluid at a partial pressure. In some embodiments, the partial pressure is greater than or equal to 1 kPa, greater than or equal to 5 kPa, greater than or equal to 10 kPa, greater than or equal to 15 kPa, greater than or equal to 20 kPa, greater than or equal to 25 kPa, greater than or equal to 30 kPa, greater than or equal to 35 kPa, greater than or equal to 40 kPa, greater than or equal to 45 kPa, greater than or equal to 50 kPa, greater than or equal to 60 kPa, greater than or equal to 70 kPa, greater than or equal to 80 kPa, greater than or equal to 90 kPa, greater than or equal to 100 kPa, greater than or equal to 120 kPa, greater than or equal to 140 kPa, greater than or equal to 160 kPa, or greater. In some embodiments, the partial pressure can be less than or equal to 160 kPa, less than or equal to 140 kPa, less than or equal to 120 kPa, less than or equal to 100 kPa, less than or equal to 90 Pa, less than or equal to 80 Pa, less than or equal to 70 kPa, less than or equal to 60 kPa, less than or equal to 50 kPa, less than or equal to 45 kPa, less than or equal to 40 kPa, less than or equal to 35 kPa, less than or equal to 30 kPa, less than or equal to 25 kPa, less than or equal to 20 kPa, less than or equal to 15 kPa, less than or equal to 10 kPa, less than or equal to 5 kPa, less than or equal to 1 kPa, or less. Combinations of these ranges are possible (e.g., greater than or equal to 1 kPa and less than or equal to 1 kPa).

In some embodiments, the target species is introduced into the first tube from the inlet at a volumetric flow rate. In some embodiments, the volumetric flow rate of the target species is greater than or equal to 0.1 sccm, greater than or equal to 0.5 sccm, greater than or equal to 1 sccm, greater than or equal to 2 sccm, greater than or equal to 3 sccm, greater than or equal to 4 sccm, greater than or equal to 5 sccm, greater than or equal to 10 sccm, greater than or equal to 20 sccm, greater than or equal to 30 sccm, greater than or equal to 40 sccm, greater than or equal to 50 sccm, greater than or equal to 100 sccm, greater than or equal to 150 sccm, greater than or equal to 200 sccm, or greater. The units sccm refers to standard cubic centimeter per minute (sccm). In some embodiments, the volumetric flow rate of the target species is less than or equal to 200 sccm, less than or equal to 150 sccm, less than or equal to 100 sccm, less than or equal to 50 sccm, less than or equal to 40 sccm, less than or equal to 30 sccm, less than or equal to 20 sccm, less than or equal to 10 sccm, less than or equal to 5 sccm, less than or equal to 4 sccm, less than or equal to 3 sccm, less than or equal to 2 sccm, less than or equal to 1 sccm, less than or equal to 0.5 sccm, less than or equal to 0.1 sccm, or less. Combinations of these ranges are possible (e.g, less than or equal to 200 sccm and greater than or equal to 0.1 sccm). The volumetric flow rate of a fluid can be measured quantitatively using a flow meter or the like.

In some embodiments, the electrochemical apparatus comprises a second tube. In some embodiments, the second tube is electrically coupled to the first tube. When the second tube is electrically coupled to the first tube, there may be an electrically conductive path between the first tube and the second tube (e.g., a conductive wire coupled to the first and the second tubes, a completed circuit wherein the first tube and the second tube are circuit elements). For example, in FIG. 1, second tube 103 can be electrically coupled to first tube 102. The conductive path, in some embodiments, comprises a circuit element (e.g., a switch) that can open and/or close the conductive path. In some embodiments, the conductive path can be a continuous conductive path. In some embodiments, the conductive path can be a discontinuous conductive path (e.g. an open switch).

The tubular electrodes for this design may take many different forms, but, according to certain embodiments, some of the requirements are a high electrical conductivity to reduce any ohmic losses and the ability to transport gas while reducing liquid leaching into the gas stream. Conceptually, some of these requirements are similar to a gas diffusion electrode, but in a tubular geometry. These requirements can be satisfied in this tubular geometry by electrically conductive hollow fiber membranes, metallic tubes with sufficiently small porosity and appropriate wetting characteristics, or layered structures. As the electrochemical process drives the selective separation of CO₂ from the gas stream, the tubular electrodes need not contain gas-selective properties, though selective polymers may enable enhanced uptake or rejection of contaminant species.

In some embodiments, the second tube comprises a wall. For example, in FIG. 2, second tube 103 comprises wall 204. The wall may comprise any of a variety of solid materials. The wall of the tube may comprise a second porous, electrically conductive material 208. In some such instances, an entirety of the wall is the first porous, electrically conductive material. However, in other embodiments, only a portion of the wall is the first porous, electrically conductive material. For example, the second porous, electrically conductive material may be an electrically conductive coating on a separate portion of the wall of a different material, such as a polymeric material. For example, the tube may comprise a hollow fiber membrane. The hollow fiber membrane (e.g., of a polymeric material such as polypropylene and/or polyetherimide) may be coated (e.g., via dip-coating) with an electrically conductive material. The wall may separate the electrolyte solution when present and the external environment from the interior of the second tube. The second porous, electrically conductive material may prevent the electrolyte from entering the interior of the second tube while allowing the target species transported from the first tube into the electrolyte solution (e.g., as part of a process of the target species being transported to the second tube). In some embodiments, the second porous, electrically conductive material is configured to allow diffusion of the target species and prevent, when present, electrolyte solution crossover into the second fluid.

The second porous, electrically conductive material may have a porosity that is sufficient for target species to be transported through the wall of the second tube but insufficient for the electrolyte solution to permeate. In some embodiments, the second porous electrically conductive material has a porosity greater than or equal to 1%, greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, or greater. In some embodiments, the second porous electrically conductive material has a porosity less than or equal to 90%, less than or equal to 80%, less than or equal to 70%, less than or equal to 60%, less than or equal to 50%, less than or equal to 40%, less than or equal to 30%, less than or equal to 20%, less than or equal to 10%, less than or equal to 5%, or less. Combinations of ranges are possible (e.g., greater than 10% and less than or equal to 90%, greater than or equal to 10% and less than or equal to 50%). Other properties of the electrochemical apparatus can be modified to control the prevention of electrolyte solution infiltration into the second fluid in the second tube (e.g., second fluid pressure, liquid/gaseous phases, polar/nonpolar compounds, electrode surface morphology, use of differences in hydrophobicity and/or hydrophilicity of the wall of the second tube and the electrolyte solution, and/or viscosity (e.g., dynamic and/or kinematic viscosity) of the electrolyte solution (where the higher the viscosity, the more difficult it is for the electrolyte solution to pass through the wall of the tube)).

In some embodiments, the second porous, electrically conductive material has an average pore size. In some embodiments, the second porous, electrically conductive material has an average pore size of less than or equal to 500 μm, less than or equal to 300 μm, less than or equal to 200 μm, less than or equal to 100 μm, less than or equal to 50 μm, less than or equal to 25 μm, less than or equal to 20 μm, less than or equal to 15 μm, less than or equal to 10 μm, less than or equal to 5 μm, less than or equal to 4 μm, less than or equal to 3 μm, less than or equal to 2 μm, less than or equal to 1 μm, less than or equal to 0.9 μm, less than or equal to 0.8 μm, less than or equal to 0.7 μm, less than or equal to 0.6 μm, less than or equal to 0.5 μm, less than or equal to 0.4 μm, less than or equal to 0.3 μm, less than or equal to 0.2 μm, less than or equal to 0.1 μm, less than or equal to 90 nm, less than or equal to 80 nm, less than or equal to 70 nm, less than or equal to 60 nm, less than or equal to 50 nm, or less. In some embodiments, the second porous, electrically conductive material has an average pore size of to 2 nm, greater than or equal to 5 nm, greater than or equal to 10 nm, greater than or equal to 20 nm, greater than or equal to 50 nm, greater than or equal to 60 nm, greater than or equal to 70 nm, greater than or equal to 80 nm, greater than or equal to 90 nm, greater than or equal to 0.1 μm, greater than or equal to 0.2 μm, greater than or equal to 0.3 μm, greater than or equal to 0.4 μm, greater than or equal to 0.5 μm, greater than or equal to 0.6 μm, greater than or equal to 0.7 μm, greater than or equal to 0.8 μm, greater than or equal to 0.9 μm, greater than or equal to 1 μm, greater than or equal to 2 μm, greater than or equal to 3 μm, greater than or equal to 4 μm, greater than or equal to 5 μm, greater than or equal to 10 μm, greater than or equal to 15 μm, greater than or equal to 20 μm, greater than or equal to 25 μm, greater than or equal to 50 μm, greater than or equal to 100 μm, or greater. Combinations of these ranges are possible (e.g., greater than or equal to 50 nm and less than or equal to 20 μm).

In some embodiments, the second porous, electrically conductive material has a low electrical resistance. In some embodiments, the second porous, electrically conductive material is or comprises a metallic material and/or metallic alloy (e.g., copper and/or copper alloys, silver and/or silver alloys, gold and/or gold alloys, aluminum and/or aluminum alloys, zinc and/or zinc alloys, nickel and/or nickel alloys, brass, bronze, iron and/or iron alloys, and/or platinum and/or platinum alloys). The second porous, electrically conductive material, in some embodiments, comprises conductive nanomaterials including but not limited to single-walled carbon nanotubes, multi-wall carbon nanotubes, silver nanoparticles, silver nanowires, and/or gold nanoparticles. In some embodiments, the second porous, electrically conductive material has a sheet resistance less than or equal to 100 Ω/cm², less than or equal to 50 Ω/cm², less than or equal to 20 Ω/cm², less than or equal to 10 Ω/cm², less than or equal to 5 Ω/cm², less than or equal to 4 Ω/cm², less than or equal to 3 Ω/cm², less than or equal to 2 Ω/cm², less than or equal to 1 Ω/cm², less than or equal to 0.5 Ω/cm², less than or equal to 0.1 Ω/cm², or less. In some embodiments, the second porous, electrically conductive material has a sheet resistance greater than or equal to 0.1 Ω/cm², greater than or equal to 0.5 Ω/cm², greater than or equal to 1 Ω/cm², greater than or equal to 2 Ω/cm², greater than or equal to 3 Ω/cm², greater than or equal to 4 Ω/cm², greater than or equal to 5 Ω/cm², greater than or equal to 10 Ω/cm², greater than or equal to 20 Ω/cm², greater than or equal to 50 Ω/cm², greater than or equal to 50 Ω/cm², or greater. Combinations of these ranges are possible (e.g., greater than or equal to 0.1 Ω/cm² and less than or equal to 50 Ω/cm²).

In some embodiments, the electrochemical apparatus has a ratio of a total volume of the electrolyte solution when present to the sum of electrochemically active surface areas of all the first and the second tubes in the apparatus. The electrochemically active surfaces area of all the first and the second tubes may comprise the total surface areas of the first porous, electrically conductive material and the second porous, electrically conductive material. In some embodiments, the ratio of the volume of the electrolyte solution to the sum of the electrochemically active surface areas of all the first and the second tubes in the apparatus is less than or equal to 10 cm, less than or equal to 5 cm, less than or equal to 1 cm, less than or equal to 5 mm, less than or equal to 1 mm, less than or equal to 0.8 mm, less than or equal to 0.6 mm, less than or equal to 0.4 mm, less than or equal to 0.2 mm, less than or equal to 0.09 mm, less than or equal to 0.07 mm, less than or equal to 0.05 mm, less than or equal to 0.03 mm, less than or equal to 0.01 mm, or less. In some embodiments, the ratio of the volume of the electrolyte solution to the sum of the electrochemically active surface areas of all the first and the second tubes in the apparatus is greater than or equal to 0.01 mm, greater than or equal to 0.03 mm, greater than or equal to 0.05 mm, greater than or equal to 0.07 mm, greater than or equal to 0.09 mm, greater than or equal to 0.2 mm, greater than or equal to 0.4 mm, greater than or equal to 0.6 mm, greater than or equal to 0.8 mm, greater than or equal to 1 mm, greater than or equal to 5 mm, greater than or equal to 1 cm, greater than or equal to 5 cm, greater than or equal to 10 cm, or greater. Combinations of these ranges are possible (e.g., greater than or equal to 1 mm and less than or equal to 10 cm). The ratio of the volume of the electrolyte solution to the sum of the electrochemically active surface areas of all the first and the second tubes in the apparatus is calculated by dividing the total volume of the electrolyte solution in the apparatus by the sum of the electrochemically active surface areas of all the first and the second tubes in the apparatus.

In some embodiments, the second tube comprises an outlet. In some embodiments, the second tube comprises the outlet configured to output the second fluid comprising the target species at the second concentration. For example, FIG. 3 describes outlet 202 configured to output second fluid 302. While the location of the outlet relative to the second tube can vary, in some embodiments, the outlet can be located at an end of the second tube. The outlet may be configured to output the second fluids out of electrochemical apparatus. In some embodiments, the second tube comprises multiple outlets configured to output the second fluid.

In some embodiments, the second tube is one of a multiplicity of second tubes. In the electrochemical apparatus, it may be beneficial for large-scale target species separation methods to have multiple second tubes in the electrochemical apparatus to improve throughput. In some embodiments, the multiplicity of second tubes comprises tubes of various geometries, lengths, materials, and/or properties. However, in some embodiments, some or all second tubes of the multiplicity of first tubes have the same geometry, materials, and/or properties. In some embodiments, the multiplicity of second tubes are parallel to each other. In some embodiments, the multiplicity of second tubes are perpendicular and/or parallel to each other. In some embodiments, each of the second tubes of the multiplicity of second tubes comprises an outlet configured to output the second fluid. The multiplicity of second tubes, in some embodiments, can be electrically coupled to the first tube and/or the multiplicity of first tubes. For example, in FIG. 5, some or all of multiplicity of first tubes 501 can be electrically coupled to some or all multiplicity of second tubes 502. It may be possible that the multiplicity of first tubes and the multiplicity of second tubes allows for relatively highly scalable target species separation that is capable of being implemented in industrial-scale processes.

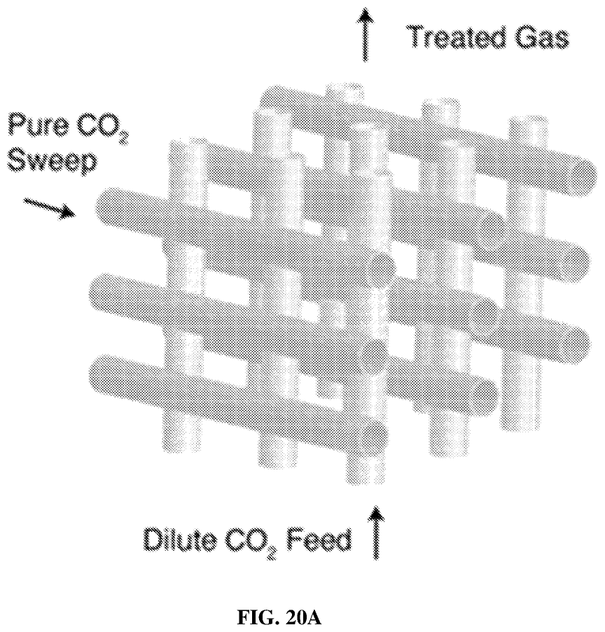

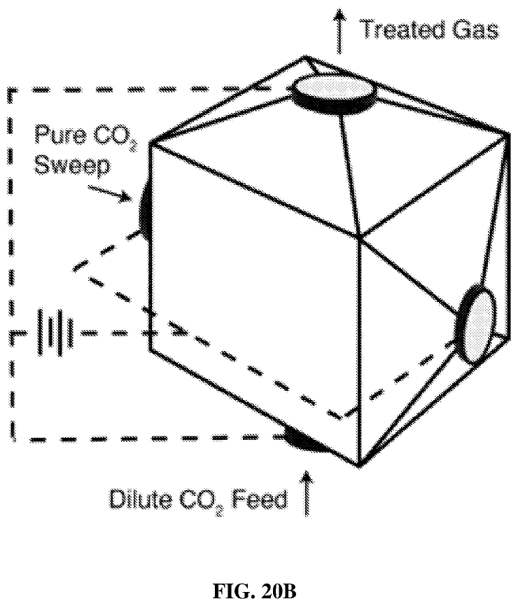

The spatial arrangement of the multiplicity of first tubes and the multiplicity of seconds tube in the electrochemical apparatus may have any of a myriad of arrangements. The arrangements may advantageously allow for more efficient transport of the target species. In some embodiments, the first tubes can be perpendicular to the second tubes. In some embodiments, the first tubes can be parallel to the second tubes. In some embodiments, the second tubes can be arranged in a polygonal structure around the first tubes and/or the first tubes can be arranged in a polygonal structure around the second tubes. In some embodiments, the first tubes and the second tubes can be arranged into an array within the chamber (e.g. alternating rows of the multiplicity of first tubes and the multiplicity of second tubes). In some embodiments, the multiplicity of first tubes and the multiplicity of second tubes can be arranged in an cross-current manner. Cross-current, in this context, describes an arrangement where the multiplicity of first tubes and the multiplicity of second tubes are perpendicular to each other such that the long axis of each of the multiplicity of first tubes is adjacent to and perpendicular to the long axis of each of the multiplicity of second tubes. One example of such an arrangement is shown in FIG. 20A.

In some embodiments, a center axis running a length of the first tube and a center axis running a length of the second tube are within 10° (or within 7.5°, within 5°, within 2°, or within 1°) of parallel to each other. In some embodiments, the center axis running the length of the first tube and the center axis running the length of the second tube are within 10° (or within 7.5°, within 5°, within 2°, or within 1°) of perpendicular to each other.

In some embodiments, the first tube can be located within an interior of the second tube in a first nested arrangement. In some embodiments, the second tube can be located within an interior of the first tube in a second nested arrangement. In the first and/or the second nested arrangements, the first tube and/or the second tube may comprise nested geometries. For example, the cross-sectional geometry of the first and the second tubes may be such that either the first or the second tube at least partially surrounds at least a portion of the other. In some embodiments, less than or equal to 99%, less than or equal to 75%, less than or equal to 50%, less than or equal to 25%, less than or equal to 10%, less than or equal to 5%, less than or equal to 2%, less than or equal to 1%, or none of the first tube is within the interior of the second tube. In some embodiments, less than or equal to 99%, less than or equal to 75%, less than or equal to 50%, less than or equal to 25%, less than or equal to 10%, less than or equal to 5%, less than or equal to 2%, less than or equal to 1%, or none of the second tube is within the interior of the first tube. In some embodiments, greater than or equal to 1%, greater than or equal to 2%, greater than or equal to 5%, greater than or equal to 10%, greater than or equal to 25%, greater than or equal to 50%, greater than or equal to 75%, greater than or equal to 99%, or more of the first tube is within the interior of the second tube. In some embodiments, greater than or equal to 1%, greater than or equal to 2%, greater than or equal to 5%, greater than or equal to 10%, greater than or equal to 25%, greater than or equal to 50%, greater than or equal to 75%, greater than or equal to 99%, or more of the second tube is within the interior of the first tube.

In some embodiments, the first tube and the second tube are not concentric. In certain embodiments, the first tube and the second tube are not nested.

In some embodiments, a portion of the first tube is relatively close to a portion of the second tube. For example, in FIG. 1, first tube 102 can be distance D1 from second tube 103. In some embodiments, the smallest distance between any portion of the first tube and any portion of the second tube is less than or equal to 1 m, less than or equal to 50 cm, less than or equal to 10 cm, less than or equal to 5 cm, less than or equal to 1 cm, less than or equal to 5 mm, less than or equal to 4 mm, less than or equal to 3 mm, less than or equal to 2 mm, less than or equal to 1 mm, less than or equal to 0.5 mm, less than or equal to 0.4 mm, less than or equal to 0.3 mm, less than or equal to 0.2 mm, less than or equal to 0.1 mm, less than or equal to 0.05 mm, less than or equal to 0.01 mm, or less. In some embodiments, the smallest distance between any portion of the first tube and any portion of the second tube is greater than or equal to 0.05 mm, greater than or equal to 0.01 mm, greater than or equal to 0.1 mm, greater than or equal to 0.2 mm, greater than or equal to 0.3 mm, greater than or equal to 0.04 mm, greater than or equal to 0.5 mm, greater than or equal to 1 mm, greater than or equal to 2 mm, greater than or equal to 3 mm, greater than or equal to 4 mm, greater than or equal to 5 mm, greater than or equal to 1 cm, greater than or equal to 5 cm, greater than or equal to 10 cm, greater than or equal to 50 cm, greater than or equal to 1 m, or greater. Combinations of these ranges are possible (e.g., greater than or equal to 0.01 mm and less than or equal to 5 mm).

In some embodiments, the electrochemical apparatus comprises a second fluid. In some embodiments, the second fluid comprises the target species at a second concentration. For example, in FIG. 4, second fluid 302 comprises the target species at second concentration 304. In some embodiments, the second fluid comprises the target species in at a concentration of less than or equal to 1%, less than or equal to 5%, less than or equal to 10%, less than or equal to 15%, less than or equal to 20%, less than or equal to 25%, less than or equal to 30%, less than or equal to 35%, less than or equal to 40%, less than or equal to 45%, less than or equal to 50%, less than or equal to 55%, less than or equal to 60%, less than or equal to 65%, less than or equal to 70%, less than or equal to 75%, less than or equal to 80%, less than or equal to 85%, less than or equal to 90%, less than or equal to 95%, less than or equal to 99%, or less, wherein the percentage is the volumetric percentage of the target species relative to the second fluid. In some embodiments, the second fluid comprises the target species at a concentration of greater than or equal to 0.1%, greater than or equal to 0.5%, greater than or equal to 1%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, greater than or equal to 95%, greater than or equal to 99%, or greater wherein the percentage is the volumetric percentage of the target species relative to the second fluid. Combinations of these ranges are possible (e.g., less than or equal to 99% and greater than or equal to 1%). In some embodiments, 100 volume percent of the second fluid is the target species (e.g., when the target species is carbon dioxide, the second fluid in the second tube is pure carbon dioxide).

In some embodiments, the electrochemical apparatus comprises a second fluid. In some embodiments, the second fluid comprises the target species at a second concentration. For example, in FIG. 4, second fluid 302 comprises the target species at second concentration 304. In some embodiments, the second fluid comprises the target species in at a concentration of less than or equal to 1%, less than or equal to 5%, less than or equal to 10%, less than or equal to 15%, less than or equal to 20%, less than or equal to 25%, less than or equal to 30%, less than or equal to 35%, less than or equal to 40%, less than or equal to 45%, less than or equal to 50%, less than or equal to 55%, less than or equal to 60%, less than or equal to 65%, less than or equal to 70%, less than or equal to 75%, less than or equal to 80%, less than or equal to 85%, less than or equal to 90%, less than or equal to 95%, less than or equal to 99%, or less, wherein the percentage is the weight percentage of the target species relative to the second fluid. In some embodiments, the second fluid comprises the target species at a concentration of greater than or equal to 0.1%, greater than or equal to 0.5%, greater than or equal to 1%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, greater than or equal to 95%, greater than or equal to 99%, or greater wherein the percentage is the weight percentage of the target species relative to the second fluid. Combinations of these ranges are possible (e.g., less than or equal to 99% and greater than or equal to 1%). In some embodiments, 100 weight percent of the second fluid is the target species (e.g., when the target species is carbon dioxide, the second fluid in the second tube is pure carbon dioxide).

In some embodiments, the first concentration of the target species (e.g., in the first tube) is different than the second concentration of the target species (e.g., in the second tube). Accordingly, the electrochemical apparatus may be capable of advantageously transporting the target species from a low concentration to a higher concentration (e.g., up a concentration gradient). In some embodiments, the second concentration is greater than the first concentration by a factor of greater than or equal to 1.01, greater than or equal to 1.05, greater than or equal to 1.1, greater than or equal to 1.2, greater than or equal to 1.5, greater than or equal to 2, greater than or equal to 3, greater than or equal to 4, greater than or equal to 5, greater than or equal to 10, greater than or equal to 100, greater than or equal to 1000, greater than or equal to 2500, or greater. In some embodiments, the second concentration is greater than the first concentration by a factor of less than or equal to 2500, less than or equal to 1000, less than or equal to 100, less than or equal to 10, less than or equal to 5, less than or equal to 4, less than or equal to 3, less than or equal to 2, less than or equal to 1.5, less than or equal to 1.2, less than or equal to 1.1, less than or equal to 1.05, less than or equal to 1.01, or less. Combinations of these ranges are also possible (e.g., greater than or equal to 1.01 and less than or equal to 2500, greater than or equal to 1.01 and less than or equal to 10). In some embodiments, the above ranges are satisfied on a volumetric basis. In some embodiments, the above ranges are satisfied on a mass basis.

In some embodiments, the electrochemical apparatus can be configured to introduce the second fluid into the second tube via an inlet on the second tube. In some embodiments, the second fluid that is introduced into the second tube at the inlet of the second tube comprises a lower concentration of the target species than that at the outlet of the second tube. The target species, after being introduced into the second tube at the inlet of the second tube, may be transported from the first tube into the second tube, through the electrolyte. Accordingly, the concentration of the target species at the outlet of the second tube can be higher than the concentration of the target species at the inlet of the second tube.

In some embodiments, the second fluid is in a second phase (e.g., a liquid, a gas, a polar fluid, a nonpolar fluid). In some embodiments, the second phase is different than the phase of the electrolyte solution. For example, the second phase may be a gaseous phase and the electrolyte solution may be in a liquid phase. In some cases, the second fluid is in a liquid phase that is immiscible with at least one phase of the liquid electrolyte solution. The use of immiscible phases between the second fluid and the electrolyte solution may limit the amount or quantity of electrolyte solution crossover into the second fluid. In some embodiments, the second tube can receive the second fluid at a first pressure. The second fluid may be pressurized to improve throughput, ensure adequate diffusion of the target species out of the first tube, and/or limit the quantity of electrolyte solution crossover into the first tube.

In some embodiments, the second fluid is part of a sweep stream. The sweep stream, in some embodiments, can transport the target species that diffuse into the second tube to another location in the electrochemical apparatus for further separation and/or out of the electrochemical apparatus. In some embodiments, the second tube comprises an inlet that can be configured to fluidically connect to a source of the sweep stream. In some embodiments, the inlet of the second tube is located on an end of the second tube. In some embodiments, the sweep stream comprises target species that have diffused from the first fluid in the first tube, through the electrolyte, into the second tube. The sweep stream may reduce back diffusion, in some embodiments, of the target species from the second tube to the first tube.

In some embodiments, the electrochemical apparatus is configured to release the second fluid from the second tube via an outlet of the second tube. In some embodiments, the second fluid that is released from the second tube comprises the target species at a higher concentration than that of the second fluid introduced into the second tube (e.g., as a sweep stream) (e.g., by a factor of at least 1.05, at least 1.1, at least 1.2, at least 1.5, at least 2, at least 5, at least 10, at least 50, at least 100, and/or up to 1000 or more). The target species, upon being introduced into the second tube (e.g., by diffusing through pores of the wall of the second tube), may be transported into the second fluid, which may be output from the second tube via an outlet.

In some embodiments, the second fluid is introduced to the second tube via an inlet as a sweep stream that is a pure stream of the target species.

The sweep stream (e.g., which may be a pure stream of the target species or comprise other fluid) may enter the inlet at a first volumetric flow rate of the target species. Then, the volumetric flow rate of the target species may be increased to a second, higher volumetric flow rate (e.g., due to introduction of additional target species from the electrolyte solution during operation of the electrochemical apparatus). The second flow rate, as measured at the outlet of the second tube, may be greater than the first volumetric flow rate by a factor of greater than or equal to 1.05, greater than or equal to 1.1, greater than or equal to 1.2, greater than or equal to 1.5, greater than or equal to 2, greater than or equal to 5, and/or up to 10, up to 50, up to 100, up to 1000, or greater. Combinations of these ranges are possible.

In some embodiments, the target species is introduced into the second tube from the inlet at a volumetric flow rate. In some embodiments, the volumetric flow rate of the target species is greater than or equal to 0.1 sccm, greater than or equal to 0.5 sccm, greater than or equal to 1 sccm, greater than or equal to 2 sccm, greater than or equal to 3 sccm, greater than or equal to 4 sccm, greater than or equal to 5 sccm, greater than or equal to 10 sccm, greater than or equal to 20 sccm, greater than or equal to 30 sccm, greater than or equal to 40 sccm, greater than or equal to 50 sccm, greater than or equal to 100 sccm, greater than or equal to 150 sccm, greater than or equal to 200 sccm, or greater. In some embodiments, the volumetric flow rate of the target species is less than or equal to 200 sccm, less than or equal to 150 sccm, less than or equal to 100 sccm, less than or equal to 50 sccm, less than or equal to 40 sccm, less than or equal to 30 sccm, less than or equal to 20 sccm, less than or equal to 10 sccm, less than or equal to 5 sccm, less than or equal to 4 sccm, less than or equal to 3 sccm, less than or equal to 2 sccm, less than or equal to 1 sccm, less than or equal to 0.5 sccm, less than or equal to 0.1, or less sccm. Combinations of these ranges are possible (e.g, less than or equal to 200 sccm and greater than or equal to 0.1 sccm). The volumetric flow rate of a fluid can be measured quantitatively using a flow meter or the like.

In some embodiments, the chamber may be capable of being at least partially filled with an electrolyte solution (e.g., a liquid electrolyte solution, an aqueous solution (such as one comprising water in an amount of greater than or equal to 50 wt %, greater than or equal to 90 wt %, greater than or equal to 99 wt %, or higher), an organic solution, a room temperature ionic liquid). In some embodiments, the electrolyte solution when present comprises an ionic solvent and an electroactive species. For example, in FIG. 4, chamber 101 capable of being at least partially filled with electrolyte solution 401 comprising electroactive species 405.

Some embodiments involve the capture of a target species from the first fluid in the first tube induced at least in part by the electrochemical activation of an electroactive species from a deactivated state to an activated state. A species that is electroactive may be capable of undergoing one or more reduction and/or oxidation reactions within the solvent window of at least one liquid solvent (e.g., water, an organic solvent such as acetonitrile, dimethylsulfoxide, N,N-dimethylformamide, tetrahydrofuran, a carbonate such as propylene carbonate, an ionic liquid, or a mixture thereof).

As a non-limiting example, if the electroactive species is an optionally-substituted quinone, the neutral quinone may be considered the deactivated state, the semiquinone (product of the addition of one electron to the neutral quinone) would be considered one activated state, and the quinone dianion (the product of the addition of one electron to neutral quinone) could also be considered the activated state.

The electroactive species may induce capture of the target species via any of a variety of mechanisms.

In some embodiments, the activated electroactive species induces capture of the target species from the fluid mixture at least in part by bonding to the target species or a portion thereof. The bonding may be a reversible process that allows for subsequent electron transfer-initiated release of the target species as opposed to starting an irreversible reaction that converts the target species to a different product (e.g., CO₂ reduction to a hydrocarbon). The bonding may be via a covalent bond, an electrostatic interaction (e.g., formation of a salt bridge), hydrogen bonding, or any of a variety of other specific or non-specific non-covalent affinity interactions. In some embodiments, the bonding is via a covalent bond. As one example of covalent bonding, the target species may be carbon dioxide and the activated electroactive species may be a quinone dianion, and an oxyanion of the quinone dianion may form a covalent bond with the carbon of the carbon dioxide, thereby forming a carbonate group covalently bound to the quinone. As another example, when the target species is HCl, the oxyanion of the quinone dianion may deprotonate the HCl (e.g., directly or via a chain of proton transfers involving for, example, the solvent), resulting in the formation of a covalent bond between the oxygen of the quinone and the proton, forming a hydroxy group and leaving a chloride ion in the fluid mixture (and thereby resulting in the HCl being captured). In some embodiments, the activated electroactive species has a higher binding constant for bonding to the target species or a portion thereof than does the deactivated electroactive species (e.g., by a factor of greater than or equal to 101, greater than or equal to 102, greater than or equal to 103, greater than or equal to 104, greater than or equal to 105, greater than or equal to 106, greater than or equal to 107 and/or up to 108, up to 109, or greater). This relationship may hold at at least one temperature, such as 298 K. The greater affinity may be due to, for example, a change in oxidation state (e.g., a reduction causing an increase in electron-density on at least a portion of the electroactive species resulting in an increase in basicity and/or nucleophilicity of the electroactive species).

In some embodiments, the activated electroactive species induces capture of the target species at least in part by causing one or more proton transfers involving at least some of the activated electroactive species and/or the target species. The activation of the electroactive species from its deactivated state may cause one or more proton transfers by, for example, the activated electroactive species having a different pKa than the deactivated electroactive species. In some such embodiments, the activated electroactive species has a higher pKa in water at 298 K than does the deactivated electroactive species. For example, the activated electroactive species may have a pKa in water at 298 K that is greater than that of the deactivated electroactive species by at least 0.5, at least 1.0, at least 2.0, at least 5.0, at least 10.0, and/or up to 12.0, up to 14.0 or greater. The activation of the electroactive species may result in a change in the pH (e.g., an increase) of the fluid mixture in which the electroactive species is present. In some such instances, the change in pH may induce capture of the target species (e.g., by shifting of dissolution and/or chemical equilibria and/or causing the target species or an acid formed by the target species to become deprotonated in solution) once the target species is exposed to the solution having the increased pH. As a specific but non-limiting example, an electrochemically induced increase in the pH of the electrolyte solution in which the electroactive species is present (or a portion thereof when a pH gradient is induced) may increase the extent to which carbon dioxide dissolves into the electrolyte solution from the first fluid due to the underlying acid-base equilibria involving carbon dioxide, carbonic acid, bicarbonate anion, and carbonate dianion.

Any of a variety of electroactive species may be employed, provided that they have at least the common quality of being able to convert between an activated state and a deactivated state via one or more electron transfer reactions as described in this disclosure to induce capture of a target species. In some embodiments, the electroactive species is selected based on its affinity in its activated state for one or more target species (e.g., carbon dioxide). In some embodiments, the electroactive species is selected based on an ability to form a strong nucleophile or strong base upon reduction. In some embodiments, the electroactive species is selected at least in part based on its solubility in a desired liquid (e.g., aqueous solutions).

In some embodiments, the electroactive species is or comprises an organic species. The species may be optionally-substituted (e.g., the species may comprise functional groups and/or other moieties or linkages bonded to the main structure of the species). In some embodiments, the organic species comprises one or more species chosen from optionally-substituted quinone, optionally-substituted thiolate, an optionally-substituted pyridine, an optionally-substituted bipyridine, an optionally-substituted phenazine, an optionally-substituted phenothiazine, and/or a redox-active amine.

The choice of substituent (e.g., functional groups) on the optionally-substituted species may depend on any of a variety of factors, including but not limited to its effect on the pKa and/or the standard reduction potential of the optionally-substituted species, and/or the solubility of the resulting species. With the benefit of this disclosure, it can be determined which substituents or combinations of substituents on the optionally-substituted species (e.g., quinone) are suitable for the electroactive species based on, for example synthetic feasibility, and resulting pKa and/or standard reduction potential.

In some embodiments, the optionally-substituted quinone is or comprises an optionally-substituted naphthoquinone. In certain cases, the optionally-substituted quinone is or comprises an optionally-substituted anthraquinone. In some embodiments, the optionally-substituted quinone is or comprises an optionally-substituted quinoline. In some embodiments, the optionally-substituted quinone is or comprises an optionally-substituted thiochromene-dione. In some embodiments, the optionally-substituted quinone is one of benzo[g]quinoline-5,10-dione, benzo[g]isoquinoline-5,10-dione, benzo[g]quinoxaline-5,10-dione, quinoline-5,8-dione, or 1-lamba⁴-thiochromene-5,8-dione. In some embodiments, the optionally-substituted quinone is or comprises an optionally-substituted phenanthrenequinone (also referred to as an optionally-substituted phenanthrenedione). The substituents (e.g., functional groups) may be any of those listed above or below.

Exemplary functional groups with which the optionally-substituted quinone may be functionalized include, but are not limited to, halo (e.g., chloro, bromo, iodo), hydroxyl, carboxylate/carboxylic acid, sulfonate/sulfonic acid, alkylsulfonate/alkylsulfonic acid, phosphonate/phosphonic acid, alkylphosphonate/alkylphosphonic acid, acyl (e.g., acetyl, ethyl ester, etc.), amino, amido, quaternary ammonium (e.g., tetraalkylamino), branched or unbranched alkyl (e.g., C₁-C₁₈ alkyl), heteroalkyl, alkoxy, glycoxy, glyme, polyalkyleneglycoxy (e.g., polyethyleneglycoxy), imino, polyimino, branched or unbranched alkenyl, branched or unbranched alkynyl, aryl, heteroaryl, heterocyclyl, nitro, nitrile, thiyl, and/or carbonyl groups, any of which is optionally-substituted. The above-mentioned functional groups may also be employed in any of the other types of electroactive species described herein (e.g., optionally-substituted thiolate, an optionally-substituted bipyridine, an optionally-substituted phenazine, and an optionally-substituted phenothiazine). As would be understood by a person of ordinary skill in the art, a heteroaryl substitution of an aromatic species such as a quinone may be a ring fused with the aromatic species. For example, a quinone functionalized with a heteroaryl group can be a quinoline-dione (e.g., a benzoquinoline-dione). Heteroatoms in rings that are part of electroactive species, may, in some instances, affect the pKa of a reduced form of the electroactive species and/or its standard reduction potential. For example, a quinoline-dione may have a more positive standard reduction potential than a naphthoquinone, and a quinoxaline-dione may have a more positive standard reduction potential than the quinoline-dione.

Non-limiting examples of electroactive species that can capture target species include, but are not limited to those described in U.S. Patent Application Publication No. 2021-0060485, entitled “Electrochemical Capture of Lewis Acid Gases,” published on Mar. 4, 2021, filed as U.S. patent application Ser. No. 17/005,250 on Aug. 27, 2020; and U.S. Patent Application Publication No. 2021-0062351, entitled “Electrochemically Mediated Gas Capture, Including from Low Concentration Streams,” published on Mar. 4, 2021, filed as U.S. patent application Ser. No. 17/005,243 on Aug. 27, 2020, each of which is incorporated herein by reference it its entirety for all purposes.

The capture of a target species generally does not involve the irreversible conversion of the target species into a different compound (e.g., having a different oxidation state). For example, in the case of CO₂, the field of CO₂ “capture” is notably distinct from CO₂ “conversion.” In this latter case of CO₂ conversion, CO₂ that has already been captured from a fluid mixture (e.g., a gas mixture) is converted into a different compound via a chemical reaction, examples of which include: carbon monoxide (CO); methanol (CH₃OH) and/or higher carbon chain alcohols like ethanol (C₂H₆O) and propanol (C₃H₈O); various ethers such as dimethyl ether (C₂H₆O) and/or other polyoxymethylene dimethyl ethers (H₃CO(CH₂O)ₙCH₃); and/or olefins of various carbon chain length such as ethylene (C₂H₄), propylene (C₃H₆), and/or butadiene (C₄H₆). Conversion of CO₂ to other carbon-based compounds is also possible. As such, CO₂ capture systems may in some instances precede CO₂ conversion systems. In general, the same distinction between “capture” and “conversion” can be made for all target species.

In some embodiments, the electroactive species is soluble in the electrolyte solution (e.g., an organic solvent, an aqueous solvent, an ionic solvent). In some embodiments, the electroactive species may not have an observable solubility limit in the ionic solvent. In some embodiments, the electroactive species is present in the electrolyte solution in an amount greater than or equal to 0.01 M, greater than or equal to 0.05 M, greater than or equal to 0.1 M, greater than or equal to 0.2 M, greater than or equal to 0.3 M, greater than or equal to 0.4 M, greater than or equal to 0.5 M, greater than or equal to 0.6 M, greater than or equal to 0.7 M, greater than or equal to 0.8 M, greater than or equal to 0.9 M, greater than or equal to 1.0 M, greater than or equal to 1.1 M, greater than or equal to 1.2 M, greater than or equal to 1.3 M, greater than or equal to 1.4 M, greater than or equal to 1.5 M, greater than or equal to 1.6 M, greater than or equal to 1.7 M, greater than or equal to 1.8 M, greater than or equal to 1.9 M, greater than or equal to 2M, greater than or equal to 3 M, greater than or equal to 4 M, greater than or equal to 5 M, greater than or equal to 10 M, or greater. The unit M is the molar concentration of the electroactive species in the electrolyte solution in moles per liter. In some embodiments, the electroactive species is present in the electrolyte solution in an amount less than or equal to 10 M, less than or equal to 5 M, less than or equal to 4 M, less than or equal to 3 M, less than or equal to 2M, less than or equal to 1.9 M, less than or equal to 1.8 M, less than or equal to 1.7 M, less than or equal to 1.6 M, less than or equal to 1.5 M, less than or equal to 1.4 M, less than or equal to 1.3 M, less than or equal to 1.2 M, less than or equal to 1.1 M, less than or equal to 1.0 M, less than or equal to 0.9 M, less than or equal to 0.8 M, less than or equal to 0.7 M, less than or equal to 0.6 M, less than or equal to 0.5 M, less than or equal to 0.4 M, less than or equal to 0.3 M, less than or equal to 0.2 M, less than or equal to 0.1 M, less than or equal to 0.05 M, less than or equal to 0.01 M, or less. Combinations of these ranges are possible (e.g., greater than or equal to 0.1 M and less than or equal to 10 M).

In some embodiments, the electrolyte solution, when present, can be held at a temperature that may improve the transport of the target species from the first tube to the second tube. Elevated temperatures (e.g., temperatures above ambient temperature) may, in some cases, increase the rate of diffusion of the target species from the first tube, through the electrolyte, into the second tube. In some embodiments, the temperature of the electrolyte solution is greater than or equal to 20° C., greater than or equal to 25° C. greater than or equal to 30° C., greater than or equal to 35° C., greater than or equal to 40° C., greater than or equal to 45° C., greater than or equal to 50° C., greater than or equal to 60° C., greater than or equal to 70° C., greater than or equal to 80° C., greater than or equal to 90° C., greater than or equal to 100° C., or greater. In some embodiments, the temperature of the electrolyte solution is less than or equal to 100° C., less than or equal to 90° C., less than or equal to 80° C., less than or equal to 70° C., less than or equal to 60° C., less than or equal to 50° C., less than or equal to 45° C., less than or equal to 40° C. less than or equal to 35° C., less than or equal to 30° C., less than or equal to 25° C., or less. Combinations of these ranges are possible (e.g., greater than or equal to 20° C. and less than or equal to 100° C.).

In some embodiments, the electrolyte solution has a viscosity that allows for the transport of target species from the first tube to the second tube, through the electrolyte. Low viscosity electrolyte solutions may allow for improved rates of diffusion of the target species from the first tube to the second tube. In some embodiments, the electrolyte solution has a dynamic viscosity of less than or equal to 3000 centipoise (cP), less than or equal to 1000 cP, less than or equal to 500 cP, less than or equal to 100 cP, less than or equal to 10 cP, less than or equal to 5 cP, less than or equal to 2 cP, less than or equal to 1 cP, or less. In certain embodiments, the electrolyte solution has a dynamic viscosity of greater than or equal to 0.01 cP, or greater than or equal to 0.1 cP. Combinations of these ranges are also possible (e.g., greater than or equal to 0.01 cP and less than or equal to 3000 cP. These dynamic viscosity ranges may be satisfied at, for example, 25° C.

In some embodiments, the electrolyte solution has a kinematic viscosity of less than or equal to 3000 cP, less than or equal to 1000 cP, less than or equal to 500 cP, less than or equal to 100 cP, less than or equal to 10 cP, less than or equal to 5 cP, less than or equal to 2 cP, less than or equal to 1 cP, or less. In certain embodiments, the electrolyte solution has a dynamic viscosity of greater than or equal to 0.001 cP, greater than or equal to 0.01 cP, greater than or equal to 0.1 cP, or greater. Combinations of these ranges are also possible (e.g., greater than or equal to 0.001 cP and less than or equal to 3000 cP. These kinematic viscosity ranges may be satisfied at, for example, 25° C.

Some embodiments comprise applying a voltage across the first tube and the second tube. A device configured to apply a voltage (e.g., power supply, battery, signal generator) can, in some cases, be used for applying the voltage across the first tube and the second tube. In some embodiments, applying a voltage across the first tube and the second tube comprises applying a voltage of greater than or equal to 0.1 V, greater than or equal to 0.5 V, greater than or equal to 1 V, greater than or equal to 1.5 V, greater than or equal to 2 V, greater than or equal to 2.5 V, greater than or equal to 5 V, greater than or equal to 10 V, or greater. In some embodiments, applying a voltage across the first tube and the second tube comprises applying a voltage of less than or equal to 10 V, less than or equal to 5 V, less than or equal to 2.5 V, less than or equal to 2 V, less than or equal to 1.5 V, less than or equal to 1 V, less than or equal to 0.5 V, less than or equal to 0.1 V, or less. Combinations of these ranges are possible (e.g., greater than or equal to 0.1 V and less than or equal to 100 V).

In some embodiments, the method for separating a target species comprises applying a constant or variable current across the first tube and the second tube. When a current is applied, a measurable voltage should be observed (e.g., voltage can be measured using a voltmeter). In some embodiments, applying a constant current across the first tube and across the second tube comprises applying a constant current of greater than or equal to 0.05 mA/cm², greater than or equal to 0.1 mA/cm², greater than or equal to 0.2 mA/cm², greater than or equal to 0.3 mA/cm², greater than or equal to 0.4 mA/cm², greater than or equal to 0.5 mA/cm², greater than or equal to 0.7 mA/cm², greater than or equal to 0.8 mA/cm², greater than or equal to 0.9 mA/cm², greater than or equal to 1.0 mA/cm², greater than or equal to 5 mA/cm², greater than or equal to 10 mA/cm², greater than or equal to 50 mA/cm², greater than or equal to 100 mA/cm², or greater. In some embodiments, applying a constant current across the first tube and across the second tube comprises applying a constant current of less than or equal to 0.05 mA/cm², less than or equal to 0.1 mA/cm², less than or equal to 0.2 mA/cm², less than or equal to 0.3 mA/cm², less than or equal to 0.4 mA/cm², less than or equal to 0.5 mA/cm², less than or equal to 0.7 mA/cm², less than or equal to 0.8 mA/cm², less than or equal to 0.9 mA/cm², less than or equal to 1.0 mA/cm², less than or equal to 5 mA/cm², less than or equal to 10 mA/cm², less than or equal to 50 mA/cm², less than or equal to 100 mA/cm², or less. Combinations of these ranges are possible (e.g., greater than or equal to 0.05 mA/cm² and less than or equal to 100 mA/cm²).

In some embodiments, the method for target species separation comprises applying the voltage across the first tube and the second tube such that the target species is transported. Applying a voltage across the first tube and the second tube may elicit a reversible electrochemical process between the target species in the first fluid and the electroactive species in the electrolyte solution. For example, applying a voltage between first tube 102 and second tube 103 may elicit reversible electrochemical process 406 between electroactive species 405 and target species 402. Advantageously, the electrochemical process may occur continuously while applying the voltage thereby allowing for efficient separating of a target species. In some embodiments, the target species is transported from a first fluid flowing through at least a portion of the first tube. The target species, in some cases, may not flow through the entirety of the first tube. While applying the voltage, the target species may diffuse out of the first fluid, through the wall of the first tube into the electrolyte (where in some instances it may be captured by a dissolved electroactive species and/or undergo an acid-base reaction). There may be at least a portion of the first tube where the target species does not flow through as the target species have diffused out of the first fluid. In some embodiments, the target species is introduced into the first tube at some point along the length of the tube.

In some embodiments, the target species is transported from a first fluid flowing through at least a portion of the first tube, through an electrolyte solution, into the second tube. The target species may diffuse through the wall of the first tube and/or the second tube via a porous, electrically conductive material. In some embodiments, the target species diffuses through the wall of the first tube without allowing the electrolyte solution to permeate the first tube and/or the second tube. As mentioned previously, the first porous, electrically conductive material and the second, porous, electrically conductive material can be configured to allow diffusion of the target species and prevent, when present, electrolyte solution crossover into the first fluid and/or the second fluid.

In some embodiments, the target species may be transported through the electrolyte solution during the transport of the target species from the first fluid to the second fluid. In some embodiments, transport through the electrolyte solution of the target species can be aided via convection of the electrolyte solution (e.g., actively mixing, stirring, convecting, agitating). In some embodiments, the method for separating a target species, further comprises actively mixing the electrolyte solution while simultaneously applying the voltage between the first tube and the second tube. The target species may be transported through the electrolyte via a reversible reaction with the electroactive species as previously discussed. The electroactive species may then diffuse (with or without a driving force such as convection) from the vicinity of the first tube to the vicinity of the second tube, where it may undergo an opposite electrochemical half reaction, thereby releasing the target species which may diffuse into the second fluid within the second tube. In some embodiments, the reversible reaction is a reduction-oxidation reaction (e.g., redox reaction).

In some embodiments, the target species may be transported from the first tube into the second tube thereby forming at least a portion of the second fluid. The target species transported from the first tube into the second tube may comprise at least a portion of the second fluid. That is, the second fluid may comprise target species that have not been transported from the first tube (e.g., sweep stream) and may have been introduced into the second tube via an inlet on the second tube.

It is believed that, in all existing electrochemically pumped, liquid membrane technologies, the electrochemical cell has been envisioned with planar, porous electrodes. This geometry functions in sandwiches of gas channels, electrodes, and liquid membranes and can be scaled either by directly expanding the electrode size or by utilizing bipolar plates and stacking cells. A tubular geometry could allow a high surface area relative to the gas channel and overall cell volume, allow access to alternative diffusional regimes given the cylindrical nature of the electrode, provide opportunities to arrange electrodes in patterns that would enhance mass transport or the electrochemical reaction, and allow for new overall system designs with practical benefits such as simple electrolyte replacement.

Limited examples of tubular electrodes have been proposed in the field of electrochemical separations, but tubular electrodes have been proposed for certain other electrochemical applications where the delivery of gas to the electrolyte near the electrode surface is important, including electrocatalysis and bioelectrochemistry. In such cases, the tubular electrode has been demonstrated to enhance mass transfer of the reactant gas to the electrode surface, demonstrating the clear benefit of the geometry. Such demonstrations have been limited to single half-cell reactions, and in general these types of devices employ a desired reaction at the tubular electrode (e.g., CO₂ reduction, microbial growth, and N₂ reduction) while employing a water splitting reaction at the counter electrode. Mixing of the reaction products from these two separate reactions is typically disfavored and thus close placement of multiple tubes of opposite polarity is not a reasonable design to enhance these systems. Instead, several designs have suggested layered tubular structures where reactions occur on the inner and outer layer of a single tube, separated by an ion-exchange membrane.

The proposed design is not a clear extension of the existing proposed tubular geometries given the chemistries of these other processes. In certain types of gas separations, however, species transport between electrodes is the primary goal of the process and such chemistries often utilize symmetric electrochemical cells, meaning they are readily amenable to a multi-electrode design. The proposed design of a multi-tubular electrochemical cell thus maintains the benefits of existing tubular electrodes but is uniquely capable of packing anode and cathode tubes in any variety of cell configurations that will enable highly efficient electrochemically driven gas separations.

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. An outlet and an inlet connected by a valve and conduits that permit flow between the outlet and the inlet in at least one configuration of the valve would be said to be fluidically connected to each other. To further illustrate, an outlet and an inlet that are connected by a valve and conduits that permit flow between the outlet and the inlet in a first valve configuration but not a second valve configuration are considered to be fluidically connected to each other both when the valve is in the first configuration and when the valve is in the second configuration. In contrast, an outlet and an inlet that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid in the first region is transported to the second region via the direct fluidic connection. Any of the fluidic connections described herein may be, in some embodiments, direct fluidic connections. In other cases, the fluidic connections may be indirect fluidic connections.

U.S. Provisional Patent Application No. 63/376,447, filed Sep. 21, 2022, and entitled “MULTI-TUBULAR ELECTROCHEMICAL CELL FOR CARBON DIOXIDE SEPARATIONS,” is incorporated herein by reference in its entirety for all purposes.

The following examples are intended to illustrate certain embodiments of the present invention, but do not exemplify the full scope of the invention.

### Example 1

Processes use to separate carbon dioxide from gas streams such as air and flue gases from power plants and other point sources may require efficient gas contacting methods to enable rapid uptake of CO₂ into the sorbent media due to the large volumes of gas required. This gas contacting operation is somewhat dependent on the method of capture, where typical liquid flow absorption systems would typically use large absorption columns, flat slab contactors or hollow fibers, while adsorption-based processes would typically use porous, packed-bed configurations. This example describes electrochemically driven transport of a concentration of CO₂ from a feed of 15% CO₂ in N₂ to a release stream of pure CO₂ using a quinone/ionic liquid static membrane. A glyme-modified naphthoquinone derivative (NQ-G2) which is infinitely soluble in many ionic liquids was used in this demonstration. Several other embodiments were also suggested that improve the diffusivity of the redox species relative to the diffusivity of CO₂ in ionic liquids and that modify the cell geometry for maximum current density. The possibility of new geometries to enhance the performance of electrochemical separations within liquid membranes utilizing a multi-tubular electrochemical cell was also realized. With this cell, enhanced current densities relative to the flat geometry were accessed and numerous new parameters for device optimization were suggested. This demonstration could have relevance to processes that pump species across a liquid membrane and may offer an opportunity to create small, modular devices with large surface areas for mass transfer relative to their volume.

### Theory

High solubility and low viscosity are important in some embodiments to the operation of a supported liquid membrane device. For a 1e⁻/CO₂ process, the total flux of CO₂, N_{CO}_{₂}, across the membrane is governed by Equation 2,

$${N}_{{CO}_{2}} = \frac{i}{F} - \frac{{D}_{{CO}_{2}}}{h} \frac{{P}_{a} - {P}_{c}}{{H}_{pc}} \qquad Equation 2$$

where i is the current density, F is Faraday's constant, D_{CO}_{₂} is the diffusivity of CO₂ in the liquid, h is the membrane thickness, H_{pc} is the Henry's constant of CO₂ in the liquid, and Pₐ and P_{c} are the anode and cathode CO₂ partial pressures, respectively. The second term in Equation 2 corresponds to back-diffusion of CO₂ from the concentrated anode to the feed cathode side. From this equation it is also possible to determine the fraction of the current that contributes to a positive flux of CO₂, as shown in Equation 3.

$$θ = \frac{{N}_{{CO}_{2}}}{i / F} \qquad Equation 3$$

A θ of one would correspond to no back diffusion and 1e⁻/CO₂, while in practice back diffusion would occur whenever the partial pressure of CO₂ at the release side exceeds that at capture and the practical limit on the efficiency is set by the limiting current in the system. It should be noted that back-diffusion is also a function of CO₂ solubility, where low solubility would limit back diffusion, but may also limit the redox process.

At steady state, assuming a fast reaction of CO₂ with reduced quinone and due to the lack of other charged, reacting species in the system, the cell current i is entirely caried by the quinone-CO₂ adduct. The limiting current in such a system is given by Equation 4, corresponding to the depletion of quinone-CO₂ adduct at one electrode.

$${i}_{lim} = \frac{4 {FD}_{{Q ( {CO}_{2} )}_{2}^{2}} - {C}_{{Q ( {CO}_{2} )}_{2}^{2 -}}^{0}}{h} \qquad Equation 4$$

Here

$${C}_{{Q ( {CO}_{2} )}_{2}^{2 -}}^{0}$$

is the initial concentration of quinone-CO₂ adducts in the system.

From Equations 2-4 it is evident that a minimum current must be sustained to overcome the back diffusion of CO₂ within the cell. To easily maintain this current, the limiting current should be in excess of the minimum, corresponding to high quinone diffusion and high concentration.

### Experimental

### Materials

2,3-dichloro-1,4-naphthoquinone, potassium tert-butoxide, tetrahydrofuran, 2-methoxyethanol, dichloroethane, magnesium sulfate, ethyl acetate, hexanes, silica gel, and Triton X-100 were purchased from Millipore Sigma. Multi-walled carbon nanotubes (10-20 μm length, 50-80 nm diameter) were purchased from cheaptubes.com. 1-ethyl-3-methylimidazolium tricyanomethanide was purchased from IoLiTec, Inc. Zinc foil (0.25 mm, 99.98%) was purchased from Alfa Aesar. Q3/2 polypropylene membranes were kindly supplied by 3M.

### Synthesis of NQ-G2

2,3-di(2-methoxyethoxy)-1,4-naphthoquinone (NQ-G2) was synthesized. 2,3-dichloro-1,4-naphthoquinone (5 g) was dissolved in THF (300 mL) inside of a N₂ filled glovebox. A mixture of 2-methoxyethanol (50 mL), THF (20 mL), and t-BuOK (5.16 g) was prepared and then added dropwise to the THF solution. After stirring for three hours, 100 ml of water was added, followed by the removal of THF by rotary evaporation. The solution was then extracted with DCE (4×100 mL). The combined organic phased was then washed with brine (150 mL), dried over MgSO₄, and filtered. Column chromatography (1:1 hexane:ethyl acetate) followed by rotary evaporation and drying overnight in a vacuum oven at room temperature produced a yellow crystalline solid (5.08 g, 75%).

### Electrochemical Measurements

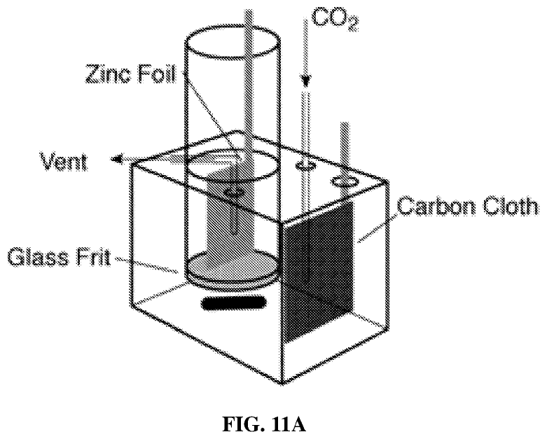

All measurements were performed with a Biologic SP-150 potentiostat. For cyclic voltammetry, a 3 mm diameter glassy carbon electrode was used as working electrode with platinum wire counter. A silver wire pseudo-reference electrode was used, with ferrocene added as internal reference following the initial scan due to the overlap of several waves. The H-cell was purchased from Adams and Chittenden and had a 5 mL volume on each chamber. A polyethylene terephthalate microporous membrane was used as separator (Sterlitech, 0.1 μm) and AVCarb G100 felt was used as the electrodes. The CV and H-cell experiments were performed at room temperature. Bulk reduction of NQ-G2 was performed in a custom box cell shown in FIG. 11A, using EC-CC1-060T carbon cloth as the working electrode and zinc foil as the counter electrode. The counter electrode glass chamber was purchased from BASi, Inc. and contained a 4-8 μm glass frit. The reduced solution was kept in a dark N₂-filled glovebox prior to use.

### Solution Characterization

Viscosity was measured with a RheoSense microVISC. Diffusion of the neutral NQ-G2 was measured by pulse field gradient NMR diffusometry on a Bruker Avance Neo 500 MHz spectrometer with a 5-mm Z-gradient broad band probe using pulse field gradient diffusometry. A pulse program with longitudinal eddy delay (Bruker's ledbpgp2 s program) was utilized. The signal decay as a function of gradient strength was fit to the appropriate Stejskal-Tanner equation. A linear decay was observed, and diffusion delays between 0.1 and 0.2 s were employed. Trace water content of the ionic liquid was determined by Karl Fischer Titration on a Mettler Toledo C20S.

### Flat Membrane Cell

A redox flow battery cell purchased from Electrochem, Inc. with titanium end plates and a serpentine flow channel was used to construct the flat membrane cell. An acrylic plate was laser cut to contain the glass fiber filter (Whatman GF/D), which was sandwiched between PETE membrane filters, 5 cm² Toray 060 wet-proof carbon paper and EC-CC1-060T carbon cloth. EPDM gaskets were used to seal the cell. The reduced quinone solution was dropped onto the glass fiber filter inside of a N₂-filled glovebox where the cell was sealed. Mass flow controllers (MasterFlex and Omega), a non-dispersive infrared CO₂ Sensor (ExplorIR, CO2meter.com), and a flow meter (Siargo FS4001-30-CV-A) were connected to the cell. A custom LabView interface controlled and recorded the setup. The cell and CO₂ sensor were loaded inside a home-built temperature-controlled chamber and maintained at 35° C.

### Tubular Electrodes

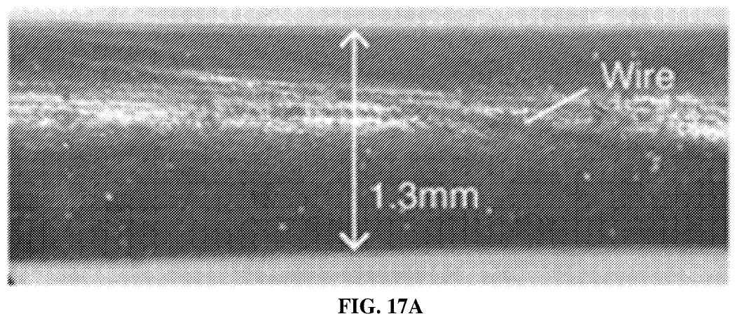

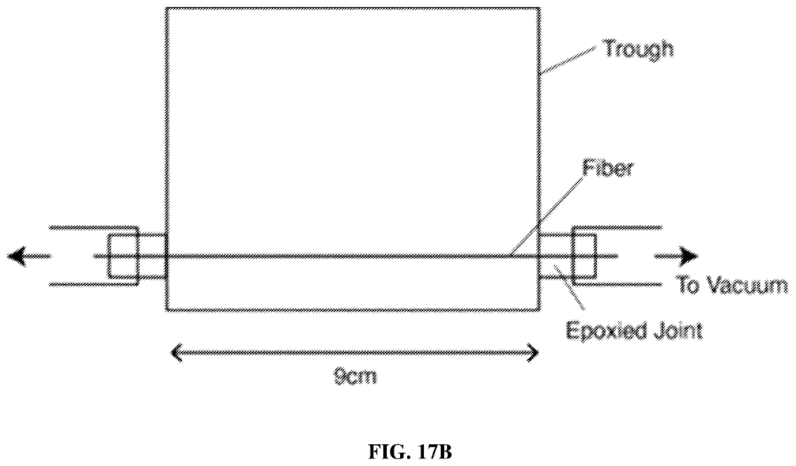

Tubular electrodes with a porous, electrically conductive layer that rejects liquid crossover were fabricated by a vacuum filtration procedure of a suspension of MWCNT onto the surface of a commercial hollow fiber membrane. The commercial hollow fiber membrane was a 3M Q3/2 polypropylene membrane, with an inside diameter of 600 μm, a wall thickness of 200 μm and a nominal 0.2 μm pore size. ˜10 cm lengths of these fibers were epoxied into a trough (depicted in FIG. 17B with vacuum connections on the fiber ends, and a 0.1 mm stainless steel wire wrapped ˜3 times around the length of the fiber. A 0.1 wt % suspension of MWCNT's with 0.1 wt % Triton X-100 surfactant in water was prepared by probe tip sonication. A 30 s sonication, 30 s rest procedure for 10 minutes was utilized at a 30% amplitude. The epoxied fiber/wire was rinsed with isopropanol to wet the porous membrane and then the MWCNT suspension was added to the trough. Vacuum (−70 kPa) was applied to the fiber, filtering the MWCNT suspension onto the outer surface of the fiber. ˜48 ml of the coating solution was filtered through the fiber, followed by rinsing with isopropanol to remove residual surfactant. Following drying in air and under vacuum, the resulting MWCNT coating fully coats the hollow fiber and wrapped wire, with a thickness of ˜150 μm. CO₂ and N₂ gas permeation were measured in a constant pressure gas permeation system. Research grade CO₂ and N₂ (Airgas) were pressurized to 2.01 bar upstream of the hollow fiber module, and permeation rates were measured using a digital flow meter. Hollow fiber modules were manufactured by sealing a length of fiber within a Swagelok® union T using quick set epoxy, pressurizing the fiber module on the shell side of the fiber. Active fiber length was estimated as the length between the two epoxy seals, 38.6 mm.

### Multi-Tubular Electrochemical Cell

The multi-tubular electrochemical cell was fabricated from an acrylic tube 9.5 mm in diameter. A 2.5 cm length was cut, and end caps were laser cut with a 4 mm spacing between tube centers. The coated hollow fibers were then epoxied into the frame. Wires from the tubes were soldered to leads and coated in epoxy, with a feed gas tube larger than each coated fiber affixed. An excess of epoxy was used to prevent leaks. The center chamber was filled through a fill port with the reduced quinone solution inside of a N₂-filled glovebox, following which the cell was affixed to gas leads and the same mass flow controller and CO₂ sensor as used with the flat cell. A Masterflex mass flow meter was used for this experiment. The cell and CO₂ sensor were loaded to the custom-built temperature control chamber and maintained at 35° C. throughout the measurement.

### Results

Given the high volumetric flow of gas necessary to capture substantial CO₂, low volatility solvents are of particular interest to liquid membrane—type electrochemical separations. The parameters for the choice of solvent aside from volatility include the ionic conductivity of the solution, solubility and molecular diffusion of the redox-active compounds, and compatibility with electrode materials. Past work has demonstrated the ability of certain ionic liquids to dissolve quinones that react with CO₂. Such systems are purely ionic and thus have essentially no volatility and very high ionic conductivity, while allowing the quinone to be reversibly reduced to perform the CO₂ separation.

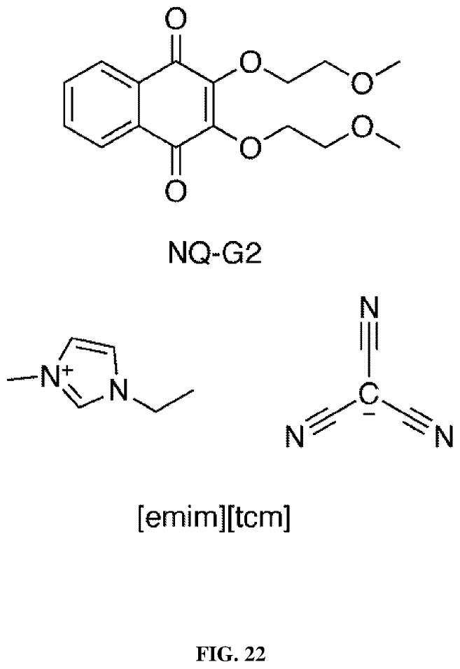

For this demonstration, the glyme-modified naphthoquinone (NQ-G2) derivative was chosen for this demonstration depicted in FIG. 22. The glyme functionality of this quinone enables exceptionally high solubility in many ionic liquids. Past work demonstrated 1-ethyl-3-methylimidazolium tricyanomethanide ([emim][tcm]) as a low viscosity ionic liquid with a good ability to dissolve quinones. No clear limit to the solubility of NQ-G2 in [emim][tcm] was observed. This high solubility enables a higher limiting current within the electrochemical cell, and because the positive flow of CO₂ from the anode (dilute feed) to the cathode (concentrated release) is directly proportional to the current, a higher current enables a greater separation.

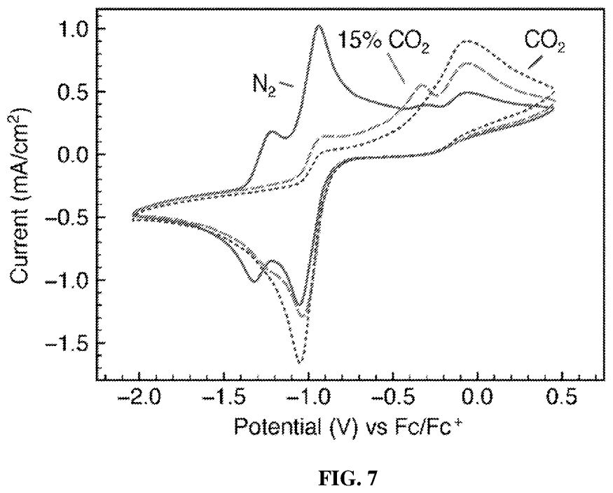

To validate the ability of NQ-G2 to capture CO₂ in [emim][tcm], cyclic voltammetry measurements were performed (FIG. 7). In this experiment 20 mM NQ-G2 was dissolved in the ionic liquid and the sample was purged with the desired gas for 10 minutes. A glassy carbon working electrode, platinum wire counter electrode, and silver wire pseudo-reference electrode were used. The experiment was referenced by adding 5 mM of ferrocene after the initial scan was obtained. The experiment was performed by scanning at 100 mV/s. Under N₂, two redox waves are evident at ˜−1V and −1.3V vs. ferrocene. Under pure CO₂, the two reduction waves (negative current) merge into a single at −1V, while under 15% CO₂ in N₂ the second wave at −1.3V is substantially smaller. The positive oxidation waves under N₂ are shifted positively to the right under either CO₂ concentration, forming a single broad wave under pure CO₂ and two waves under 15% CO₂. These observations are all consistent with past work on quinone reduction with CO₂ where a chemical reaction of CO₂ with the reduced quinone occurs. This chemical reaction causes a positive shift in the reduction wave because of the altered electronics of the aromatic ring, and the added energy to break the C—O bond results in the significant positive shift in the oxidation potential. This experiment thus validates the ability of the quinone to reversibly react with CO₂ and perform the intended operation in a liquid membrane.

### Multi-Tubular Electrochemical Cell

Tubular electrodes with a porous, conductive layer that rejects liquid crossover were fabricated by a vacuum filtration procedure of a suspension of multi-walled carbon nanotubes (MWCNT) onto the surface of a commercial hollow fiber membrane. The commercial hollow fiber membrane was a 3M Q3/2 polypropylene membrane, with an inside diameter of 600 μm, a wall thickness of 200 μm and a nominal 0.2 μm pore size. ˜10 cm lengths of these fibers were epoxied into a trough (depicted in FIG. 17B) with vacuum connections on the fiber ends, and a 0.1 mm stainless steel wire wrapped ˜3 times around the length of the fiber. A 0.1 wt % suspension of MWCNT's (30-50 nm, 10-20 μm length) with 0.1 wt % Triton X-100 surfactant in water was prepared by probe tip sonication. A 30 s sonication, 30 s rest procedure for 10 minutes was utilized at a 30% amplitude. The epoxied fiber/wire was rinsed with isopropanol to wet the porous membrane and then the MWCNT suspension was added to the trough. Vacuum (−70 kPa) was applied to the fiber, filtering the MWCNT suspension onto the outer surface of the fiber. ˜48 ml of the coating solution was filtered through the fiber, followed by rinsing with isopropanol to remove residual surfactant. Following drying in air and under vacuum, the resulting MWCNT coating fully coats the hollow fiber and wrapped wire, with a thickness of ˜150 μm. A representative coated fiber is shown in FIG. 17A.

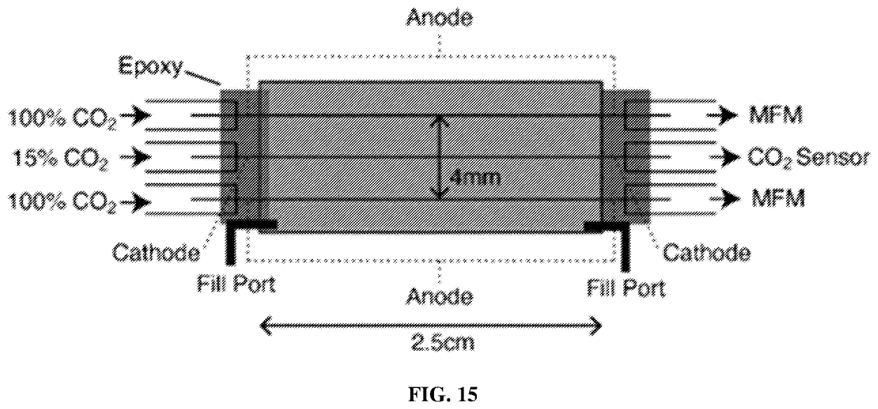

A demonstration cell with four coated hollow fibers was built inside of an acrylic cylindrical tube. A diagram of the demonstration cell is shown in FIG. 15. The four tubes are held in place by 3M DP100NS epoxy and a header plate. The tube centers are spaced 4 mm apart. The wire wrapped beneath the MWCNT layer on each tube was extracted from the CNT layer outside of the center chamber and soldered to extended lead wires. A feed gas tube was then placed on the end of each tubular electrode and epoxy was applied to the wires, tubes, and tubular electrodes to seal the chamber and electrical contacts. The center chamber of the cell had a 2.5 cm length and a 9.5 mm inside diameter. Fill ports were included to add the ionic liquid/quinone solution.

To perform the CO₂ separation experiment, the starting quinone solution must first be reduced 50% to generate NQ-G2²⁻ species in solution. A 1.75M NQ-G2 in [emim][tcm] solution was prepared in a 5 mL volumetric flask. The starting solution was then loaded to a custom bulk reduction cell with a carbon cloth working electrode. A glass tube with a porous frit end was then placed in the solution and loaded with pure ionic liquid and a zinc foil counter electrode. Both solutions were purged with CO₂ and a continuous flow of CO₂ was supplied to the working electrode chamber. The NQ-G2 was then reduced in the working electrode chamber with an applied potential of ˜1.3V over the course of approximately 8 days until the charge passed was 50% of the total capacity of the initial NQ-G2. During this time, Zn²⁺ ions are stripped into solution in the counter electrode chamber and form a precipitate with the tricyanomethanide anions. Some NQ-G2 is lost to the counter electrode chamber.

The final prepared solution contains a mixture of NQ-G2, NQ-G2 (CO₂)₂²⁻, and [emim][tcm]. 3.2 g of this solution was loaded to the four-electrode demonstration cell. Two of the tubular electrodes were electrically connected to the working electrode, while two were connected to the counter electrode. Y joints in the gas flow were included to evenly split the entering gas between the two tubes of either polarity. 15% CO₂ in N₂ was fed to the working electrode tubes, while pure CO₂ was fed to the counter electrode tubes. An infrared CO₂ sensor monitored the gas composition on the exit of the working electrode, while a mass flow meter monitored the flow rate of the pure CO₂ stream. The cell and gas flow connections were all loaded into a temperature-controlled chamber and kept at 35° C. throughout the experiment.

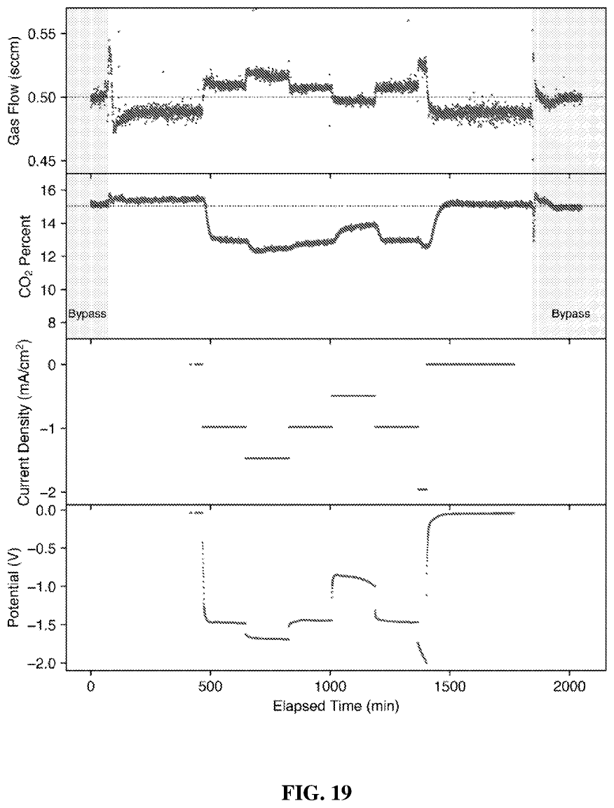

FIG. 19 depicts the exiting gas concentration, exiting pure CO₂ flow rate, applied current, and cell potential during the experiment. At the beginning, the cell is bypassed such that the entering flow (0.5 sccm) of gases went directly to the exit sensors. After stabilization of the sensor readings, flow was switched to enter the multi-tubular cell, and the readings were again allowed to stabilize. The higher CO₂ concentration in the feed stream and lower flow of exiting pure CO₂ is the result of diffusion of CO₂ down the concentration gradient between the two sets of electrodes.

Once the cell is fully equilibrated after ˜400 minutes on stream, constant currents between 1 and 4 mA were applied, corresponding to current densities between 0.49 mA/cm² and 1.96 mA/cm². When the current is applied, the exiting concentration of CO₂ drops substantially, and the exiting CO₂ flow rate increases. The dotted line on the FIG. indicates the entering composition and flow rate; exiting flows higher than this inlet and compositions lower than the inlet indicate a net positive separation of CO₂. At current densities greater than 0.49 mA/cm², the multi-tubular cell clearly demonstrates continuous separation of CO₂ from the entering 15% CO₂ in N₂ mixture and release into a pure CO₂ sweep stream.

It should be understood that the subject matter defined in the appended claims is not necessarily limited to the specific implementations described above. The specific implementations described above are disclosed as examples only.

### Example 2

This example described herein demonstrates further experimentation using the aforementioned materials and methods.

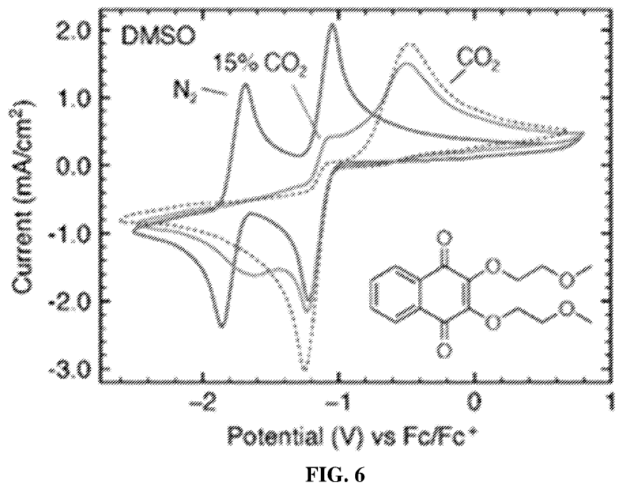

FIG. 6 illustrates the electrochemistry of NQ-G2 in a standard nonaqueous solvent, DMSO (FIG. 6) and in [emim][tcm] (FIG. 7) in the presence of different gas headspaces, with the structure of NQ-G2 inset in FIG. 6. In DMSO under N₂, NQ-G2 exhibits two redox waves at −1.2V and −1.8V vs ferrocene/ferricenium (Fc/Fc⁺), corresponding to reduction to a semiquinone radical anion species and then the dianion quinone. In the presence of CO₂, the two redox waves merged to a single wave, depending on the CO₂ concentration. When equilibrated with 15% CO₂ in N₂, the second wave was broader and shifted positively. The oxidative waves were also shifted positively, forming a relatively sharp peak under CO₂, while under 15% CO₂ there was a broader wave which begins at an earlier potential. Without wishing to bound to any particular theory, CO₂ may have reacted with the semiquinone radical species, forming a semiquinone radical adduct that can be reduced a second time at the same electrode potential as the first reduction event. On oxidation, the breaking of the quinone-CO₂ bond may have required additional energy and thus a more positively shifted potential. An alternative mechanism wherein the presence of CO₂ can promote disproportionation of the semiquinone species into dianions, enhancing the reaction rate towards further semiquinone formation can also be possible. In either case, it is believed that the presence of CO₂ caused the two-electron reduction process to occur at a single potential near ˜−1.2V vs Fc/Fc⁺, and the oxidation wave to shift positively.

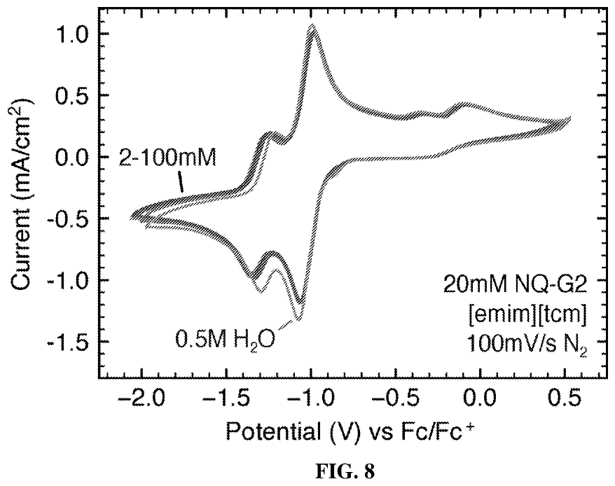

In [emim][tcm], the overall behavior of NQ-G2 was similar to that in DMSO, though there were some differences aside from the overall lower magnitude of current resulting from higher viscosity. The second wave under N₂ is somewhat suppressed relative to the first, and there appear to be smaller oxidation waves present at higher potentials. This could suggest a relatively strong interaction between the reduced NQ-G2 and the ionic liquid, or it could be related to the presence of trace water in the ionic liquid (measured to be around 500 ppm by Karl Fischer titration). These waves or the primary reduction and oxidation waves did not change with the addition of water to the ionic liquid until the water concentration was 0.5 M (see FIG. 8). Up to 100 mM of added water, only minor differences in the CV curve can be observed. At 0.5 M water, the second reduction wave begins to shift positively, and the first wave magnitude begins to increase. No effect on the higher oxidation waves was observed. While the positive shift in reduction and oxidation waves in the presence of CO₂ is still evident, the positive shift of the oxidation wave is larger than in DMSO. Under 15% CO₂, two oxidation waves were present, possibly corresponding to the mono- and di-adduct species. Cell performance in a supported liquid membrane system can be impacted by the aforementioned difference in electrochemistry. The energetics of the separation process were at minimum E=FV_{cell}, where V_{cell} is determined by the reduction and oxidation of the quinone and adduct species, respectively. Maintaining CO₂ concentration at the reduction electrode is thus important such that the dianion can be formed with limited additional energy input needed to reach the second potential. In the supported liquid membrane, CO₂ was maintained at the reduction electrode with a dilute feed gas due to back-diffusion from the counter electrode. This is in contrast to multi-stage systems where CO₂ may be introduced to the system in an absorption step after the electrochemical cell.

The glyme tail on the modified naphthoquinone (termed liquid quinone, LQ) species of this example imparted high solubility of the LQ, promoting blending of the LQ with relatively low-polarity glymes at high concentration. Due to the importance of quinone diffusion within a supported membrane, a decrease in the size of the quinone molecule was sought. It has previously been found that 2,3-di(2-methoxyethoxy)-1,4-naphthoquinone, an LQ with a shorter glyme tail, is a solid at room temperature, but it has been observed in the context of this disclosure that the ether functionality still imparted high solubility in ionic liquids. No solubility limit was observed at ambient temperature with [emim][tcm], but instead, the solid readily formed a liquid with addition of small amounts of ionic liquid. Therefore, the performance of this quinone, termed NQ-G2 for the remainder of this work, was investigated in [emim][tcm].

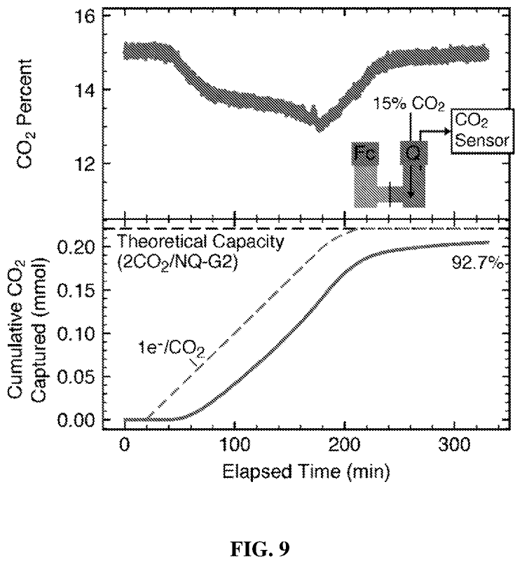

To demonstrate the capacity of NQ-G2 in [emim][tcm] and confirm a 1e⁻/CO₂ process with 2 CO₂ per quinone, a bulk reduction of NQ-G2 within an H-cell was performed, as illustrated in the inset of FIG. 9. 5 mL of 25 mM NQ-G2 in [emim][tcm] was loaded into one chamber of the H-cell, and 5 mL of 60 mM Fc in [emim][tcm] was loaded in the second chamber. A microporous PETE membrane filter separated the two chambers. Relatively low concentration NQ-G2 was used in this experiment given the low solubility of ferrocene in [emim][tcm]. A constant current-constant potential charge was used to reduce the NQ-G2 until the full capacity was reached. The applied voltage was kept below 2V to ensure no degradation of the ionic liquid, while 15% CO₂ in N₂ was continuously purged through the quinone chamber. The ferrocene chamber was initially saturated with 15% CO₂ but sealed during the remainder of the experiment. FIG. 9 shows the CO₂ sensor reading as a function of experiment time, with the integration of this curve in the lower panel. The horizontal dashed line notes the expected total capacity of the solution, while the grey dashed line (calculated from the current) notes the expected approach to this total capacity assuming 1e⁻/CO₂. 92.7% of the theoretical capacity was achieved, demonstrating that the quinone does react with 2 CO₂ per molecule, that a 1e⁻/CO₂ process should be expected, and that NQ-G2 can capture CO₂ from a dilute feed stream in the ionic liquid system. The shift from the 1e⁻/CO₂ line corresponds to the timescale for mass transfer in the system. As the membrane separator used here is non-selective, reasonably high crossover rates would be expected and thus continued cycling was not attempted.

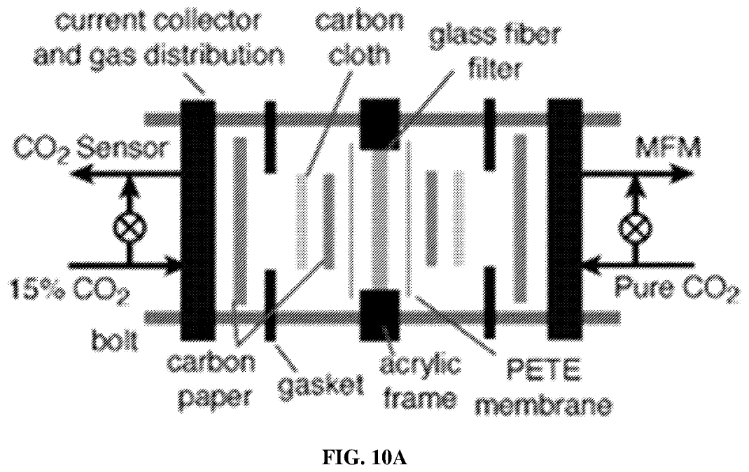

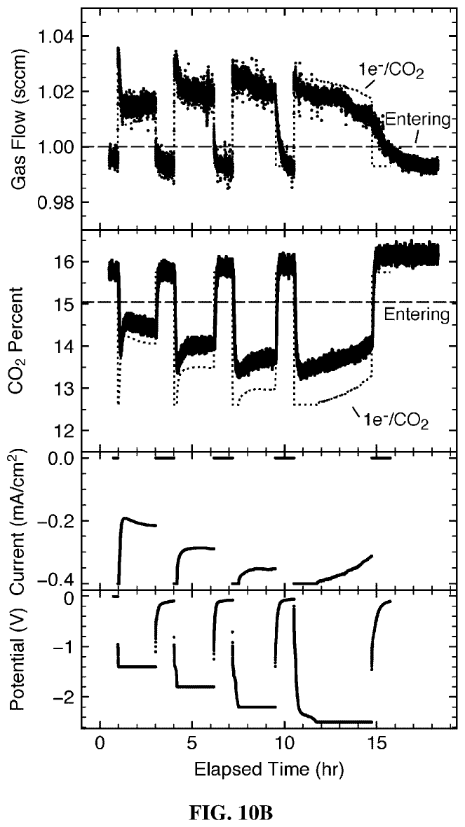

A continuous separation process using a liquid membrane was demonstrated using this bulk understanding of the quinone—CO₂ reaction. The stacked cell layout chosen for this demonstration is depicted in FIG. 10A. To maintain the liquid membrane between two carbon paper gas diffusion electrodes, a porous glass fiber filter was used as support. Two layers of the wet-proof carbon paper limited ionic liquid movement into the gas flow. The current collector plate was etched with a serpentine gas flow channel to increase the gas residence time inside of the cell. The cell, NDIR CO₂ sensor and flow meter were loaded into a home-built temperature control chamber maintained at 35° C. for the duration of the experiment. Bypass valves allowed calibration of the sensors prior to the experiment. For the supported liquid membrane device to operate in the manner desired for this experiment, the solution between electrodes contains the neutral NQ-G2 as well as reduced NQ-G2. Bulk reduction of a 1.5M NQ-G2 solution was performed in the custom cell depicted in FIG. 11A to minimize the volume of solution needed. A zinc foil counter electrode was utilized, separated from the NQ-G2 solution by a microporous glass frit. Zn²⁺ is not significantly soluble in the ionic liquid and forms a precipitate during the process, limiting crossover into the primary chamber. CV on the reduced quinone solution (FIG. 11B) did not show substantial evidence of Zn plating, suggesting that this method limited crossover of Zn. Some loss of NQ-G2 to the counter-electrode chamber was observed. Also shown are a linear sweep of [emim][tcm] with an excess of ZnCl₂ present to show the approximate plating potential of Zn²⁺ and a background CV of the pure [emim][tcm]. The NQG2 CV curves were recorded at 20 mM. Each scan was performed at 100 mV/s with a glassy carbon working electrode, Pt counter electrode, and a Ag wire reference, with ferrocene added afterwards.

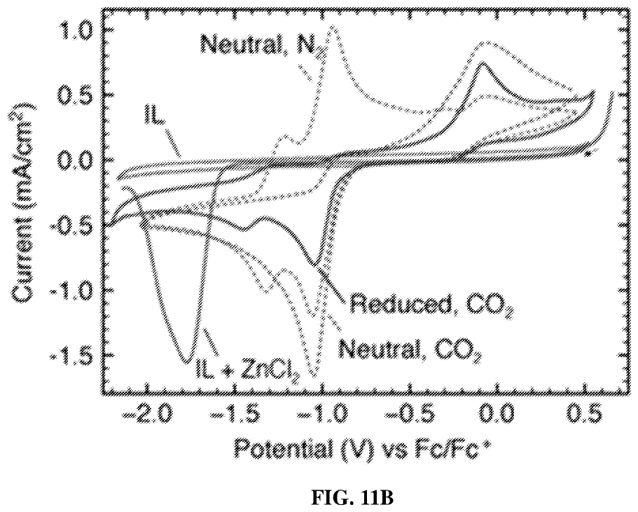

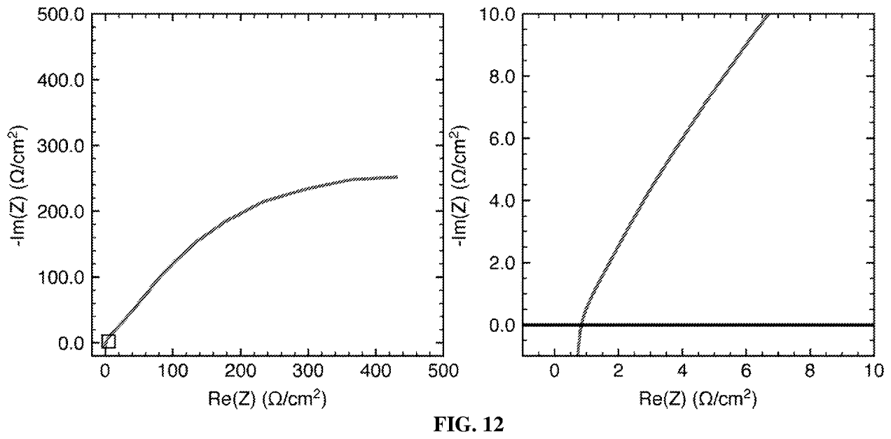

FIG. 10B depicts operation of the flat cell after ˜25 hours of stabilization of chamber temperature and feed gas flows through the cell. FIG. 12 shows the ohmic resistance of the cell after stabilization was below 1 Ω/cm². The top panel (FIG. 10B) refers to the flow of pure CO₂ exiting the sweep side, while the CO₂ percent reports the concentration exiting from the feed (cathode) of the cell. The working electrode was affixed to the cathode, thus negative currents and potentials correspond to capture from the dilute feed and release into the sweep stream. The top panels include a line indicating the entering flow and concentration, respectively. Table 1 shows the parameters used for this estimated back-diffusion. The estimated back-diffusion relatively fit the experimental baseline, when accounting for the increased viscosity of the reduced solution relative to published values for the CO₂ diffusion coefficient in [emim][tcm]. From this baseline that includes the back diffusion, the expected capture and release of CO₂ in a 1e⁻/CO₂ process was estimated, noted as the dotted line in FIG. 10B.

TABLE 1
Parameters for the estimation of back - diffusion in [emim][tcm]
for the flat cell geometry.

| Parameter | Value | | Source |
|---|---|---|---|
| Viscosity of [emim][tcm] at 35° C. | 10.4 | cP | Measured |
| Viscosity of 1.5M NQ-G2 in | 24.6 | cP | Measured |
| [emim][tcm] at 35° C. | | | |
| Viscosity of 50% reduced 1.5M | 31.1 | cP | Measured |
| NQ-G2 in [emim][tcm] at 35° C. | | | |
| CO₂ Diffusion Coefficient, D_{co}_{₂} | 1.2 × 10⁻¹⁰ | m²/s | Scaled by viscosity from the |
| | | | value in [emim][tcm] at |
| | | | 35° C.⁵⁰ |
| NQ-G2 Diffusion Coefficient, D_{Q} | 3.6 × 10⁻¹¹ | m²/s | Measured at 1.5M in |
| | | | [emim][tcm], 35° C., neutral |
| | | | NQ-G2 |
| Hₚₓ | 74 | bar | Interpolated from Ref. ¹⁸ |
| Anode CO₂ Partial Pressure, Pₐ | 101,325 | Pa | Atmospheric Pressure |
| Cathode CO₂ Partial Pressure, P_{c} | 15,239 | Pa | 15.04% entering gas |
| Film Thickness | 0.8 | mm | Experimental |
| Electrode Area | 5 | cm² | Experimental |

Four experiments were run in succession with the flat cell, operating as constant current-constant voltage with sequentially increasing cutoff potentials. A constant current of 0.4 mA/cm² was applied with cutoff voltages of −1.4, −1.8, −2.2, and −2.5V. Each segment was then allowed to run for two hours, reaching an apparent current plateau and constant gas readings. For the final segment at the highest potential, the cell was allowed to run longer than 2 hours because the current continuously decayed, but no plateau was apparent, possibly indicating degradation of the ionic liquid or quinone at this high potential. From these experiments, any exit gas concentration reading below the entering value of 15% and gas flow readings above the entering 1 sccm corresponded to a net positive flux of CO₂ up the concentration gradient. Thus, in each experiment a net positive separation was achieved. By averaging each of the readings over the duration of each experiment, several metrics can be calculated for this net separation, as summarized in Table 2. Metrics were determined from both the capture and release side to compare the uptake and release. The reported CO₂ fluxes are the fluxes in or out of the cell relative to the entering values without any consideration for back diffusion in the calculation. The expected current utilization, θ_{expected}, is based on the calculated back diffusion and the actual average current density during each experiment assuming a perfect 1e⁻/CO₂ process, while θ_{capture} and θᵣₑₗₑₐₛₑ were calculated from the actual current and actual molar flux of CO₂ simply as θ=FN_{CO}_{₂}/i.

TABLE 2
Performance metrics for the flat cell experiments in FIG. 10A.

| Experiment | | 1 | 2 | 3 | 4 |
|---|---|---|---|---|---|
| Cutoff (V) | | −1.4 | −1.8 | −2.2 | −2.5 |
| Average Current Density (mA/cm²) | | −0.21 | −0.29 | −0.36 | −0.38 |
| θ_{expected} | | 0.56 | 0.69 | 0.75 | 0.76 |
| Capture | Actual Capture Flux (μmol/m²s) | 8.6 | 16.7 | 22.5 | 22.2 |
| | θ_{capture} | 0.40 | 0.55 | 0.60 | 0.56 |
| | Energy based on capture (kJ/mol) | 335 | 314 | 352 | 433 |
| Release | Actual Release Flux (μmol/m²s) | 19.7 | 26.3 | 29.9 | 23.8 |
| | θᵣₑₗₑₐₛₑ | 0.92 | 0.87 | 0.80 | 0.60 |
| | Energy based on release (kJ/mol) | 147 | 200 | 266 | 403 |

| | | | | |
|---|---|---|---|---|
| Capture Flux/Release Flux (ratio) | 0.44 | 0.64 | 0.75 | 0.93 |

In the first experiment, θ_{capture} was less than the expected value, indicating lower uptake than 1e⁻/CO₂ or greater back-diffusion, while θᵣₑₗₑₐₛₑ was greater than the expected value, nearly approaching unity. These values should, however, be equivalent. Examining the actual fluxes, the capture flux was less than half observed on release, and this value increased in each experiment until the final experiment where the capture and release were within 10% of each other. This imbalance may be due to a longer than expected buildup to a full steady state concentration gradient, where despite reasonably flat capture, release, and electrochemical values, the cell is not fully operating in steady state. The set of experiments demonstrated several important features of the electrochemically pumped liquid membrane and suggested important considerations for the next stage in design.

As demonstrated by the capture and release energy for each step, the required energy to operate the supported membrane is relatively high. To achieve appreciable current densities in this system, relatively high potentials were necessary. As the minimum cell voltage in this system is roughly 1V to continuously oxidize and reduce quinone, the minimum expected energy is approximately 100 kJ/mol. Higher potentials resulted in larger currents and, as indicated by the increasing values of expected, would lead to higher current efficiencies, but the increase in efficiency is offset by the necessarily larger separation energy associated with high potentials.

The absolute value of the current densities achieved, and corresponding CO₂ separation fluxes, should also be noted. Rough calculations show that increased fluxes are necessary. For example, to treat the exhaust of a 600 MWₑ coal power plant at ˜500 m³/s and 13% CO₂, assuming a CO₂ flux of 0.0222 mmol/m² s, 130 million m² of cell area would be necessary, compared to estimates for traditional membranes of between 1 and 10 million m². While other applications such as smaller, distributed sources, may provide better opportunities for this technology, higher flux would still lead to enhanced performance. In the electrochemically pumped membrane technology, enhancing flux primarily suggests increasing the limiting current density, either through sorbent/electrolyte engineering or cell design. To illustrate the latter possibility, the design of electrochemical cells in a cylindrical geometry was investigated.

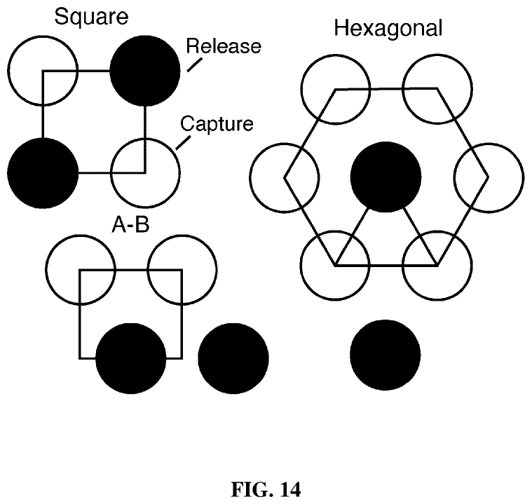

The conceptual device illustrated in FIGS. 13A and 13B was considered. Conductive, porous tubes acted as the anode and cathode of the cell, with gas fed to the inside of the tube and the electrolyte filling the space surrounding the tubes. The limiting current density and current efficiency at that limiting current for three example packing patterns was calculated and illustrated in FIG. 14. A square packing pattern allows alternating capture and release tubes while hexagonal packing facilitates more dense arrays of tubes. Hexagonal packing can either be arranged as A-B stacks to have an equal number of cathode and anode tubes, or in a true hexagonal pattern where twice as many of one electrode would be present. FIG. 14 outlines the unit cell for these three geometries. The design was restricted, for this initial analysis, to two tube diameters (0.5 mm and 1 mm) and equally sized and spaced anode and cathode tubes. Numerous adjustments to this design are possible.

Without consideration for metrics external to the supported liquid membrane, where tubular geometries have benefits in device construction, Flat and tubular geometries were compared based on the ratio of electrolyte volume to electrode surface area (V/A). For the flat geometry, this ratio simplifies to the inter-electrode spacing. To decrease cost and increase capture, low values of V/A would be desired.

No theoretical minimum spacing exists for a flat geometry until the double layer thickness is approached, suggesting this geometry would always be able to access higher current densities by simply using thinner spacing. In practice, however, substantial challenges may be involved in constructing cells with infinitesimally thin, uniform liquid films and porous. The tubular geometry therefore advantageously shows potential to access enhanced performance for a given electrolyte system while also offering practical benefits including but not limited to the ability to refill the electrolyte despite narrow spacing and scalability via additional tubes. This embodiment was limited to a few of many potential geometries, only considers the parameters for the NQ-G2/[emim][tcm] electrolyte, and does not consider the possibility of adding convection to the system. Convection, in particular, is a unique advantage of the tubular geometry where convection in the direction of current is not possible for exceptionally thin planar geometries.

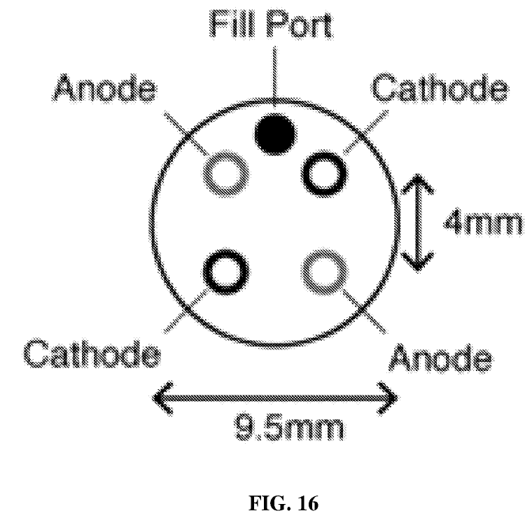

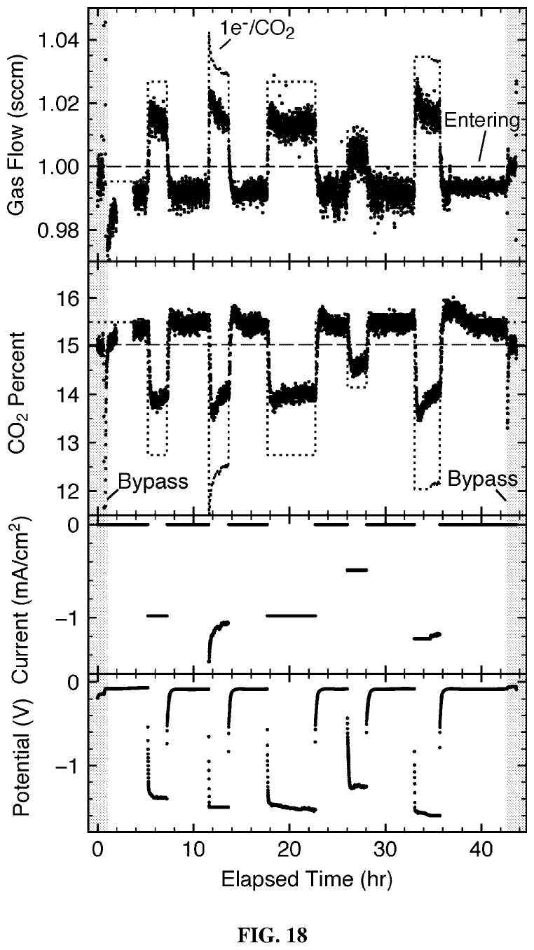

The operation of the four-tube cell (FIG. 15 and FIG. 16) is shown in FIG. 18, with several different experiments over the course of over 40 hours of experiment time. In the top panel, the total sweep pure CO₂ flow from the cell, combined from the two anode tubes, is shown. The second panel indicates the concentration of CO₂ in the exiting stream after combining the stream from both anode tubes. The total cell current density and potential are shown as well. This cell comprised an approximate electrode area of 1 cm² per tube. The reported current density is summed over two tubes. To establish the cell concentration gradients, prior to this set of experiments, the cell was operated at −1 mA/cm² for two hours. As indicated on the figure, before and after this set of experiments, the cell was also fully bypassed to verify calibration of the mass flow meter and CO₂ sensor. The entering gas flow of CO₂ and CO₂ concentration are noted by green dashed lines on the figure. When the flow was switched through the cell, the exiting pure CO₂ flow was lower, and the exiting concentration of feed was higher as a result of back-diffusion across the cell. The observed back diffusion was approximately 4× higher than predicted, where the true observed back-diffusion baseline is noted by the ‘Fit’ line on the figure. Minor differences in the position of each tube inside of the cell can have a large impact on the back-diffusion, where a 1 mm change in tube spacing can correspond to a factor of two in back-diffusion. This higher back-diffusion could also be attributed to any small bubbles in the liquid within the cell, which cannot easily be observed through the dark electrolyte. With the fit line of back-diffusion, FIG. 18 also plots the expected exiting concentration and flow based on a 1e⁻/CO₂ process as the dotted line.

Five experiments were performed to test the operation of the four-tube cell, with the intention of keeping a lower cell potential than in the flat geometry. In the first, a constant −0.98 mA/cm² was applied to the cell, much higher than the current achieved in the flat cell geometry. In the four-tube cell, the cell potential did not exceed the cutoff of −1.4V over two hours. In the second experiment, a constant −1.5V was applied for two hours, showing a high initial current that decayed to slightly higher than the first experiment and leveled off. Extended operation was then tested with a six-hour experiment at the same −0.98 mA/cm², during which the cell potential was higher than in the initial experiment and increased slowly but was relatively stable for the final hour. Two additional experiments at a lower and higher current density are also shown in FIG. 18. The four-tube cell contains electrodes spaced farther than in the flat cell and thus a long approach to steady state operation was expected. FIG. 19 contains an experiment run after this set on the same cell, with 15 hours of continuous operation that demonstrates no further increase in cell potential or drifting that would be indicative of continuing transients. This additional experiment also included a second CO₂ sensor on the exiting pure CO₂ stream, verifying that no substantial N₂ crossover was observed, within the error on this type of measurement.

From this set of measurements, performance metrics equivalent to those determined for the flat cell can be calculated, as summarized in Table 3. In this cell, the capture and release fluxes were well balanced in the experiments, though the fourth experiment at a lower current density exhibits the highest imbalance. There, the capture flux was higher than the release, possibly indicating that there was a lower driving force to release CO₂ from the solution at lower current. The energy of capture and release was similar for each of the experiments after the first and in the same range as with the flat cell. A higher potential was necessary in the flat geometry, but here the current utilization was somewhat lower. It should be noted that this lower current utilization may also reflect a higher mass transfer resistance in the home-built and relatively non-optimized conductive tubular electrodes, as compared to the gas permeability of commercial carbon papers. The pure CO₂ permeance of the conductive fibers was estimated to be 26,000 GPU, around 10,000 times lower than the carbon paper. The fibers had a CO₂:N₂ selectivity of 0.85, indicating near Knudsen selectivity. Despite the lower current utilization and relatively high energetics, the CO₂ flux achieved in this geometry was approximately double that achieved in the flat cell, clearly illustrating the potential of this type of cell. This experiment thus demonstrates the use of tubular electrodes in electrochemically mediated CO₂ separations.

TABLE 3
Performance metrics for the four-tube cell experiments in FIG. 6. Cutoff
voltage is only noted for experiments which reached the voltage.

| Experiment | | 1 | 2 | 3 | 4 | 5 |
|---|---|---|---|---|---|---|
| Cutoff (V) | | — | −1.5 | — | — | −1.6 |
| Average Current Density (mA/cm²) | | −0.98 | −1.11 | −0.98 | −0.49 | −1.22 |
| Capture | Actual Capture Flux (μmol /m²s) | 45.0 | 46.3 | 41.0 | 16.7 | 48.5 |
| | θ_{capture} | 0.44 | 0.40 | 0.40 | 0.33 | 0.38 |
| | Energy based on capture (kJ/mol) | 301 | 358 | 361 | 367 | 397 |
| Release | Actual Release Flux (μmol/m²s) | 49.2 | 54.6 | 42.3 | 13.2 | 56.9 |
| | θᵣₑₗₑₐₛₑ | 0.48 | 0.48 | 0.42 | 0.26 | 0.45 |
| | Energy based on release (kJ/mol) | 275 | 304 | 350 | 465 | 338 |

| | | | | | |
|---|---|---|---|---|---|
| Capture Flux/Release Flux (ratio) | 0.91 | 0.85 | 0.97 | 1.27 | 0.85 |

In this example, continuous electrochemically driven CO₂ separation from a 15% feed, with release at 100% CO₂, was demonstrated at bench scale with redox-active compounds in nonvolatile ionic liquid solvents. The solubility limits of quinones in ionic liquids with ether functional groups on NQ-G2 was first determined, and the ability of NQ-G2 to capture two CO₂ molecules per quinone in [emim][tcm] was then verified. Utilizing a highly concentrated, 50% reduced NQ-G2 in [emim][tcm] solution, the desired gas separation in a flat cell was demonstrated. An estimation of back-diffusion by CO₂ down the concentration gradient fit the experimentally measured crossover. Overall performance metrics demonstrated relatively high energetics that could be attributed to slow diffusion of NQ-G2 in [emim][tcm] and the intrinsic 1V separation of oxidation and reduction with NQ-G2. Additional overpotential to drive the observed currents in the flat cell may also be attributed to sluggish reaction kinetics on the wet-proof carbon paper electrodes employed to prevent leakage.

Tubular geometries for the electrochemical cell were investigated and the NQ-G2 sorbent electrolyte was employed to demonstrate the feasibility of this concept. The ability to concentrate CO₂ across split banks of tubular, porous electrodes was demonstrated with a four-tube cell that contained two cathodic absorption tubes and two anodic desorption tubes. This design could allow for rapid scaling of device area in compact formats and access to new diffusion profiles in the cylindrical geometry. Other embodiments could optimize electrode sizes individually to match reaction or sorption kinetics, place electrodes at optimal absorption and desorption locations within the cell, and/or incorporate modifications including mixing on the liquid side or three-dimensional architectures like that illustrated in FIGS. 20A and 20B. Appropriate electrical connections can allow application of the applied voltage difference between the two sets of fiber electrodes.

This work demonstrates the importance of considering the oxidative process and minimizing the spacing between reduction and oxidation. Additional analysis of process targeting, where appropriate targets for CO₂ flux, feed concentration, and desired purity could be defined. This work additionally demonstrates the utility of ether functionality in enhancing solubility in ionic liquids, and that this functionality can be targeted in future design. New embodiments that achieve more competitive energetic metrics can be possible by coupling cell design, such as the multi-tubular geometry, to the redox species' design.

### Example 3

This example describes preparation and characterization of tubes having walls comprising a porous, electrically conductive materials comprising silver nanoparticles, as well as a related electrochemical apparatus.

Tubes for use as part of electrodes for target species separation were prepared by dip-coating polyetherimide (PEI) hollow fibers in dip-coating solutions. The fibers were 9.8 cm long. The dip-coating solutions for the samples were prepared by combining 2.85-3.5 g of sintered silver metal nanoparticles, 0.15-0.3 g of multi-walled carbon nanotubes, 0.05-0.1 g of sodium dodecyl benzene sulfonate (SDBS), 0.1 g of polyvinyl alcohol (PVA), and 20 mL of deionized water. The dip-coating was performed using a 10 second soaking time of the hollow fibers in the dip-coating solutions, a 3 cm/minute withdraw velocity, a 90 second residence time for air drying, and 3-5 soakings per sample in the dip-coating solution. The dip-coating was performed at 25° C. Other soaking times were also performed to assess the effect of soaking time on measured resistance of the resulting tubes comprising walls coated with the mixture comprising silver nanoparticles and carbon nanotubes.

Resistance measurements as a function of soaking time indicated a resistance of 1.2-1.5 ohm/cm for the tubes dip-coated with a 10 second soaking time. A 30 second soaking time resulted a larger resistance by a factor of approximately 2, and a 2 minute soaking time resulted in a larger resistance by a factor of approximately 20. A comparative tube formed by dip-coating a fiber in Triton 13X showed a resistance of approximately 90 Ohm/cm. Electrochemical Impedance Spectroscopy (EIS) in 1 M NaCl aqueous solution indicated a measured resistance of 12 ohms for the 9.8 cm coated fiber.

Morphological characterization using scanning electron microscopy revealed a meso-macro-porous substructure with finger-like voids. The thickness of the porous, electrically conductive material layer comprising the sintered silver nanoparticles and the carbon nanotubes was measured to be 8.5 microns. The resulting tube had an outer diameter of 680 microns and an inner diameter of 350 microns. Advantageously, the electrically conductive coating was observed to be uniform and defect-free, with an interconnected porous structure established by connections between carbon nanotubes and the silver nanoparticles, and a high porosity of the layer was observed.

Permeance testing of the resulting tubes formed by the dip-coating and with a comparative pristine PEI tube was performed by measuring nitrogen gas flow as a function of time, with the fibers epoxied inside a t-joint with a vent to air. The closed vent gas flow for both the dip-coated fiber and the comparative PEI tube was measured at 1.97 sccm, while the open vent measurements were 1.89 sccm and 1.90 sccm, respectively. These permeance measurements indicated almost no change of the permeance before and after the coating process and no significant change in mass transfer resistance caused by the presence of the porous, electrically conductive material layer comprising the silver nanoparticles.

Cyclic voltammetry in [emim][tcm] ionic liquid were performed using the coated fiber as a working electrode and a platinum wire counter electrode with and without the presence of dichloro-naphthoquinone. It was observed that the reduction and oxidation waves for the dichloro-naphthoquinone did not overlap with the Ag/Ag⁺ redox couple. This result indicates that various types of electroactive species could be employed with the silver nanoparticle-coated fibers of this example in a multi-tubular system for target species separation.

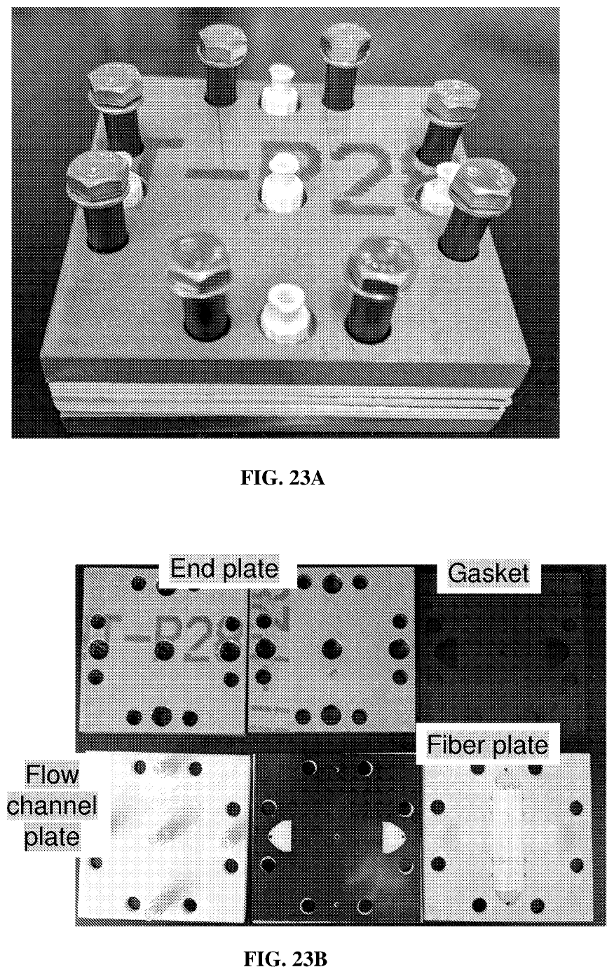

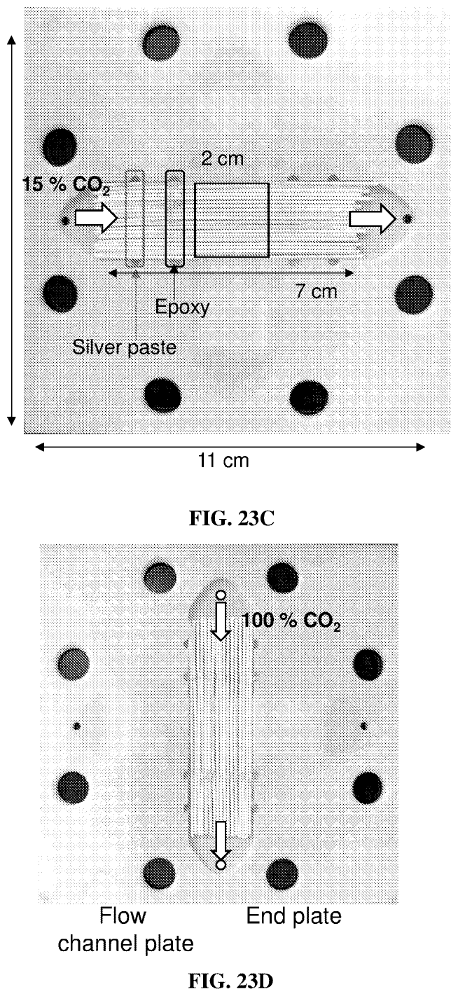

FIGS. 23A-23D show annotated photographs of one example of an embodiment of an electrochemical apparatus for target species separation using a cell employing the tubes comprising silver nanoparticle-coated hollow fibers of this example. FIG. 23A shows a photograph of the assembled cell, FIG. 23B shows a photograph of the disassembled cell including end plates, a gasket, a flow channel plate, and a fiber plate to which the tubes were epoxied. FIG. 23C shows the front side of the fiber plate, while FIG. 23D shows the back side of the fiber plate. When assembled, the first tubes (shown in FIG. 23C) and second tubes (shown in FIG. 23D) are arranged in a cross-packed (cross flow) arrangement with a less than 100-micron distance between the respective fiber bundles, which could facilitate a fast diffusion between adducts of the electroactive species and the target species (e.g., a CO₂-quinone adduct). While CO₂ is indicated as the target species in these annotated photographs, other target species could similarly be employed.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B.” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “cither,” “one of,” “only one of.” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrochemical apparatus for target species separation, comprising:
a chamber capable of being at least partially filled with an electrolyte solution, the chamber comprising:
a first tube, at least a portion of which is surrounded by the electrolyte solution when present, the first tube comprising:
a wall comprising a first porous, electrically conductive material; and
an inlet configured to receive a first fluid comprising a target species at a first concentration, wherein the first porous, electrically conductive material is configured to allow diffusion of the target species and prevent, when present, electrolyte solution crossover into the first fluid; and
a second tube, at least a portion of which is surrounded by the electrolyte solution when present, the second tube being electrically coupled to the first tube, the second tube comprising:
a wall comprising a second porous, electrically conductive material; and
an outlet configured to output a second fluid comprising the target species at a second concentration, wherein the second porous, electrically conductive material is configured to allow diffusion of the target species and prevent, when present, electrolyte solution crossover into the second fluid.

2. The electrochemical apparatus of claim 1, wherein the first tube is one of a multiplicity of first tubes and/or the second tube is one of a multiplicity of second tubes.

3. The electrochemical apparatus of claim 1, wherein the first fluid comprises a first phase and wherein the electrolyte comprises a second phase that is different and/or immiscible with the first phase.

4. The electrochemical apparatus of claim 1, wherein the inlet is fluidically connected to a source of the first fluid.

5. The electrochemical apparatus of claim 1, wherein the electrolyte solution comprises a dissolved electroactive species, wherein the dissolved electroactive species is capable of reversibly reacting with the target species.

6. The electrochemical apparatus of claim 1, wherein the first concentration is different than the second concentration.

7. The electrochemical apparatus of claim 1, wherein the smallest distance between any portion of the first tube and any portion of the second tube is less than or equal to 5 mm.

8. The electrochemical apparatus of claim 1, wherein a ratio of a total volume of the electrolyte solution to the sum of the electrochemically active surface areas of all first and second tubes in the apparatus is less than or equal to 5 mm.

9. The electrochemical apparatus of claim 1, wherein the target species comprises carbon dioxide.

10. The electrochemical apparatus of claim 1, wherein the first porous, electrically conductive material and/or the second, porous electrically conductive material comprises silver nanoparticles, silver nanowires, single-wall carbon nanotubes, multiwall carbon nanotubes, gold nanoparticles, a metallic material, and/or a metallic alloy.

11. A method for separating a target species, comprising:
applying a voltage across a first tube and a second tube such that a target species is transported from a first fluid flowing through at least a portion of the first tube, through an electrolyte solution, into the second tube, thereby forming at least a portion of a second fluid output from an outlet of the second tube;
wherein:
the first tube comprises:
a wall comprising a porous, electrically conductive material; and
an inlet configured to receive the first fluid comprising the target species at a first concentration; and
the second tube comprises:
a wall comprising a porous, electrically conductive material; and
the outlet, wherein the outlet is configured to output the second fluid comprising the target species at a second concentration.

12. The method for separating a target species of claim 11, further comprising actively mixing the electrolyte solution while simultaneously applying the voltage across the first tube and the second tube.

13. The method for separating a target species of claim 12, further comprising transporting the target species from the electrolyte solution through the wall of the first and/or second tube without the electrolyte solution permeating the first and/or second tube.

14. (canceled)

15. An electrochemical cell comprising a multiplicity of hollow inlet tubes and a multiplicity of hollow outlet tubes, wherein the tubes are configured to transport gases, and wherein the tubes are surrounded by an electrolyte solution, wherein the walls of the tubes comprise a porous, electrically conductive membrane, wherein the membrane is configured to allow diffusion of the gases and prevent liquid crossover into the gases, wherein the tubes are electrically connected to a means of applying a voltage between the inlet and outlet tubes, wherein the electrolyte solution upon applying the voltage comprises reactants that react with CO₂ transported into the inlet tubes, and produce CO₂ transported out of the outlet tubes.

16. The electrochemical cell of claim 15, wherein the electrolyte solution comprises a glyme-modified naphthoquinone (NQ-G2) derivative dissolved in 1-ethyl-3-methylimidazolium tricyanomethanide ([emim][tcm])

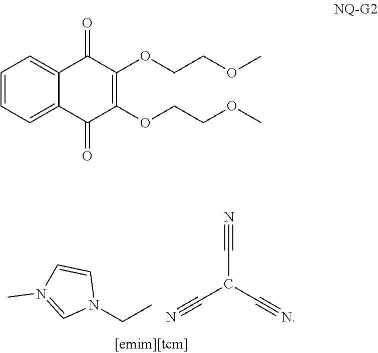

17. The electrochemical cell of claim 16, wherein 50% of the NQ-G2 species are reduced to NQ-G2²⁻ before applying a voltage across the walls of the tubes.

18. The electrochemical cell of claim 15, wherein the walls of the tubes comprise a hollow fiber membrane coated by multiwalled carbon nanotubes.

19. The electrochemical cell of claim 18, wherein the hollow fiber membrane comprises polypropylene membrane.

20. A method of separating CO₂ from a gas stream using the electrochemical cell of claim 15, comprising pumping the gas stream comprising CO₂ through the inlet tubes and collecting concentrated CO₂ from the outlet tubes.
